(19) United States
(12) Patent Application Publication
(10) Pub. No.: US 2026/0331351 A1
(43) Pub. Date: Oct. 22, 2026

(54) Coil Device and Power Converter

(71) Applicant: Mitsubishi Electric Corporation, Chiyoda-ku, Tokyo (JP)

(72) Inventors: Naoki TAKIGAWA, Chiyoda-ku, Tokyo (JP); Tomohito FUKUDA, Chiyoda-ku, Tokyo (JP); Kenta FUJII, Chiyoda-ku, Tokyo (JP); Yuji SHIRAKATA, Chiyoda-ku, Tokyo (JP); Hiroyuki YAHARA, Chiyoda-ku, Tokyo (JP)

(73) Assignee: Mitsubishi Electric Corporation, Chiyoda-ku, Tokyo (JP)

(21) Appl. No.: 19/115,080

(22) PCT Filed: Nov. 15, 2023
(86) PCT No.: PCT/JP2023/041073

§ 371 Date: Mar. 25, 2025

(30) Foreign Application Priority Data
Nov. 30, 2022 (JP) 2022-191443

(51) Int. Cl. H01F 27/22; H01F 27/28; H01F 27/32; H01F 30/06; H02M 3/00

(52) U.S. Cl. CPC H01F 27/22; H01F 27/2804; H01F 27/2876; H01F 27/324; H01F 30/06; H02M 3/003

(57) ABSTRACT

A coil device includes a core, a first winding portion, and a second winding portion. Each of the first winding portion and the second winding portion is wound around the core so as to pass through an inner region of the core surrounded by the core. A metal base substrate including a coil pattern formed on a metal base body with an insulating layer in between is disposed in the inner region of the core and an outer region of the core. A first cooling body is thermally bonded to the metal base body opposite to a side on which the insulating layer is formed. Each of the first winding portion and the second winding portion includes the coil pattern.

### TECHNICAL FIELD

The present disclosure relates to a coil device and a power converter.

### BACKGROUND ART

For example, a coil device, such as a transformer or a smoothing reactor, is mounted in a power converter such as a direct-current (DC)-DC converter. The coil device mounted in the power converter is composed of a coil and a core. The core has the function of forming a magnetic path, which is a path of magnetic lines of force generated by a current flowing through the coil. In the power converter, direct current or alternating-current (AC) voltage is applied to the coil of the coil device.

Setting the frequency of the AC voltage to a high frequency can reduce the size of the core and the number of turns of the coil, thereby contributing to miniaturization of the coil device. In recent years, for miniaturization of a coil device and a power converter with the coil device mounted therein, a switching element that can handle high switching frequencies of 1 kHz or more is used as a switching element mounted in the power converter.

The heat generation associated with energization of the coil device is roughly divided into Joule heat generation occurring in the coil and heat generation occurring in the core. Joule heat generation increases inversely with the cross-sectional area of a wire used as the coil. Thus, if a wire having a small cross-sectional area is used for miniaturization of the coil device, Joule heat generation occurring in the coil device increases.

In addition, when an alternating current flows, the current flows only near the surface of the wire due to the skin effect, thus increasing the electrical resistance of the coil device. When the frequency of the alternating current flowing through the wire increases, the electrical resistance value increases monotonically.

Thus, as the frequency of the AC voltage applied to the coil device is set to a higher value for miniaturization of the coil device, the electrical resistance value of the wire of the coil device increases due to the skin effect, leading to an increase in Joule heat generation occurring in the coil device.

Therefore, the coil device is required to have higher heat dissipation performance in order to suppress a rise in the temperature of the coil device, which is caused by Joule heat generation or the like occurring in the coil device, such that the temperature becomes equal to or less than an allowable temperature. In other words, in order to miniaturize the coil device, it is also required to improve the heat dissipation performance of the coil device. Proposed for the coil device proposed in PTL 1 is a technique of dissipating heat generated from the coil in the inner region of the core via a printed circuit board and a coil.

### CITATION LIST

### Patent Literature

PTL 1: WO 2014/141670 A1

### SUMMARY OF INVENTION

### Technical Problem

As described above, the coil device is required to have enhanced heat dissipation performance for miniaturization.

The present disclosure has been made as part of such development. An object of the present disclosure is to provide a coil device that can have improved heat dissipation performance. Another object of the present disclosure is to provide a power converter to which such a coil device is applied.

### Solution to Problem

A coil device according to the present disclosure is a coil device including a coil unit. The coil unit includes one or more cores, a metal base substrate, a first winding portion, a second winding portion, and one or more cooling bodies. The core has a loop-shaped magnetic path. The metal base substrate is disposed in an inner region of the core surrounded by the core and an outer region of the core, and includes a first coil pattern and a second coil pattern formed on a metal base body with an insulating layer in between. The first winding portion includes the first coil pattern and is wound around the core so as to pass through the inner region of the core. The second winding portion includes the second coil pattern, is wound around the core so as to pass through the inner region of the core, and is electrically insulated from the first winding portion. The cooling body includes a first cooling body bonded to the metal base body opposite to a side on which the insulating layer is formed. The metal base substrate includes a first metal base substrate and a second metal base substrate. The first coil pattern is formed in the first metal base substrate. The second coil pattern is formed in the second metal base substrate. The first metal base substrate and the second metal base substrate are disposed to face each other such that an insertion portion is formed between the first metal base substrate and the second metal base substrate, the core being inserted through the insertion portion.

A power converter according to the present disclosure is a power converter including the coil device described above.

### Advantageous Effects of Invention

In the coil device according to the present disclosure, the heat generated in a portion of each of the first winding portion and the second winding portion which is located in the outer region of the core is dissipated to the first cooling body via the insulating layer and the metal base body. In addition, the heat generated in a portion of each of the first winding portion and the second winding portion which is located in the inner region of the core is dissipated to the first cooling body via the insulating layer and the metal base body. As a result, the heat generated in the portion of each of the first winding portion and the second winding portion which is located in the inner region of the core can be dissipated to the first cooling body to the same extent as the heat generated in the portion of each of the first winding portion and the second winding portion which is located in the outer region of the core.

The power converter according to the present disclosure, which includes the coil device described above, can have improved heat dissipation performance.

### BRIEF DESCRIPTION OF DRAWINGS

FIG. 1 is a circuit diagram showing an example power converter to which a coil device according to each embodiment is applied.

FIG. 2 is an exploded perspective view of the example power converter including the coil device according to Embodiment 1.

FIG. 3 is an enlarged exploded perspective view showing a structure of the coil device in the power converter in Embodiment 1.

FIG. 4 is a sectional view taken along the sectional line IV-IV shown in FIG. 2 in Embodiment 1.

FIG. 5 is a diagram for illustrating the reason for providing a slit portion in a metal base substrate in Embodiment 1.

FIG. 6 is an exploded perspective view showing a current path of the coil device in Embodiment 1.

FIG. 7 is an exploded perspective view showing an example variation of the power converter including the coil device.

FIG. 8 is a sectional view of an example coil device according to Modification 1 Embodiment 1.

FIG. 9 is a sectional view of an example coil device according to Modification 2 in Embodiment 1.

FIG. 10 is a sectional view of an example coil device according to Modification 3 in Embodiment 1.

FIG. 11 is a sectional view of an example power converter including a coil device according to Embodiment 2.

FIG. 12 is a sectional view of a coil device according to an example of Modification 1 in Embodiment 2.

FIG. 13 is a sectional view of a coil device according to another example of Modification 1 in Embodiment 2.

FIG. 14 is a sectional view of a coil device according to an example of Modification 2 in Embodiment 2.

FIG. 15 is a sectional view of a coil device according to another example of Modification 2 in Embodiment 2.

FIG. 16 is a sectional view of an example power converter including a coil device according to Embodiment 3.

FIG. 17 is a sectional view of an example power converter including a coil device according to Embodiment 4.

FIG. 18 is a sectional view of an example coil device according to a modification in Embodiment 4.

FIG. 19 is a partial plan view showing the arrangement relationship between a core and a metal base substrate in a power converter including a coil device according to Embodiment 5.

FIG. 20 is a partial plan view showing the arrangement relationship between a core and a metal base substrate in a coil device according to Modification 1 in Embodiment 5.

FIG. 21 is a partial plan view showing the arrangement relationship between a core and a metal base substrate in a coil device according to Modification 2 in Embodiment 5.

FIG. 22 is a perspective view of an example power converter including a coil device according to Embodiment 6.

FIG. 23 is a partial plan view of the power converter including the coil device in Embodiment 6.

FIG. 24 is a partial sectional view taken along the sectional line XXIV-XXIV shown in FIG. 23 in Embodiment 6.

FIG. 25 is an enlarged exploded perspective view showing a structure of the coil device in the power converter in Embodiment 6.

FIG. 26 is a perspective view of an example power converter including a coil device according to a modification in Embodiment 6.

FIG. 27 is a partial plan view of the power converter including the coil device in Embodiment 6.

FIG. 28 is a partial sectional view taken along the sectional line XXVIII-XXVIII shown in FIG. 27 in Embodiment 6.

### DESCRIPTION OF EMBODIMENTS

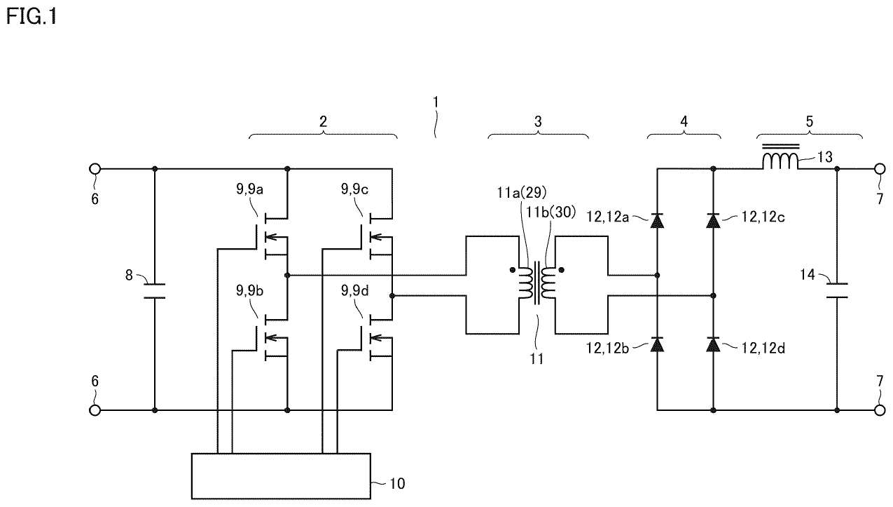

First, a DC-DC converter will be described as an example power converter including a coil device. FIG. 1 shows an example circuit diagram of the DC-DC converter. The DC-DC converter is mounted in, for example, an electric vehicle. The DC-DC converter has the function of converting an input voltage of a lithium-ion battery, which is about 100 V to 300 V, into a voltage of 12 V to 15 V and outputting the converted voltage to charge a lead storage battery.

As shown in FIG. 1, the DC-DC converter as a power converter 1 includes an inverter circuit unit 2, a transformation unit 3, a rectifier circuit unit 4, a smoothing circuit unit 5, an input terminal 6, an input capacitor 8, a control circuit unit 10, and an output terminal 7.

Inverter circuit unit 2 is configured of a switching element 9. In this case, inverter circuit unit 2 is composed of four switching elements 9a, 9b, 9c, and 9d. As switching element 9, a power semiconductor element, such as a metal oxide semiconductor (MOS) field effect transistor (MOSFET) or an insulated gate bipolar transistor (IGBT), is used. The switching operations of four switching elements 9 are controlled by control circuit unit 10.

Transformation unit 3 is composed of a transformer 11 having a primary winding portion 11a and a secondary winding portion 11b. Rectifier circuit unit 4 is configured of a rectifier element 12. Herein, rectifier circuit unit 4 is composed of four rectifier elements 12a, 12b, 12c, and 12d. As rectifier element 12, for example, a power semiconductor element, such as a diode, a MOS transistor, or a thyristor, is used. Smoothing circuit unit 5 is composed of a smoothing reactor 13 and a smoothing capacitor 14.

In the DC-DC converter as power converter 1, a DC voltage input from input terminal 6 is converted into an AC voltage by control circuit unit 10 controlling the switching operation of each of the four switching elements 9 in inverter circuit unit 2.

In transformation unit 3, the AC voltage converted in inverter circuit unit 2 is converted into an arbitrary voltage by transformer 11. The voltage to be converted is determined by the winding ratio between primary winding portion 11a and secondary winding portion 11b in transformer 11. Transformer 11 electrically insulates input terminal 6 from output terminal 7.

In rectifier circuit unit 4, the AC voltage supplied from transformation unit 3 is again converted into a DC voltage by rectifier element 12. In smoothing circuit unit 5, the DC voltage converted by rectifier circuit unit 4 is smoothed by smoothing reactor 13 and smoothing capacitor 14. This stabilizes the output voltage output from output terminal 7.

In power converter 1 shown in FIG. 1, transformer 11 and smoothing reactor 13 are coil devices that generate relatively high amounts of heat. It is necessary to dissipate the heat generated in each of transformer 11 and smoothing reactor 13 and lower the respective temperatures of transformer 11 and smoothing reactor 13 to, for example, an allowable temperature of about 100 °C to 120 °C or less. Each embodiment will specifically describe the structure for causing a coil unit configured of a coil unit to dissipate heat.

### Embodiment 1

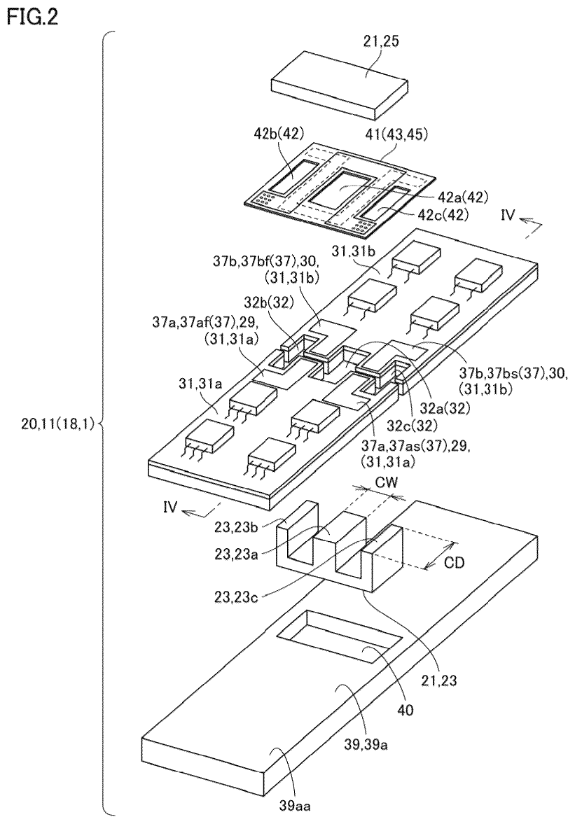

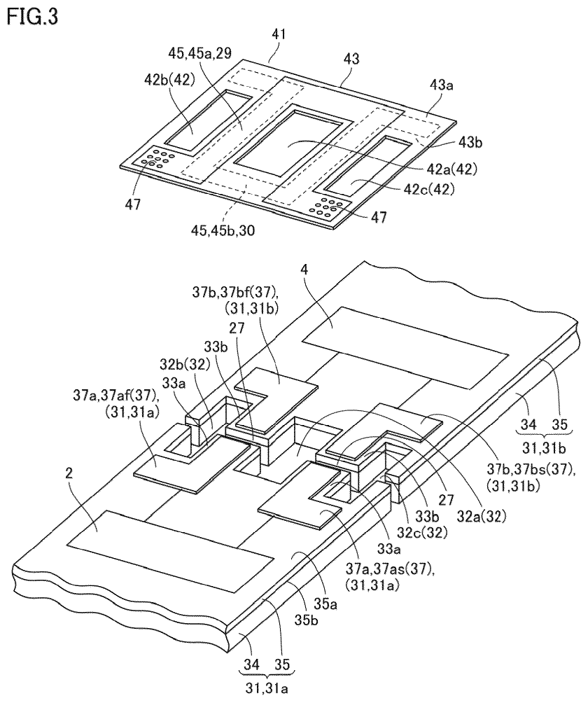

Embodiment 1 will describe a first example of the transformer as a coil device. As shown in FIGS. 2, 3 and 4, a coil device 20 is configured of one coil unit 18. Transformer 11 as coil device 20 is formed of a core 21 having a loop-shaped magnetic path, and a first winding portion 29 (primary winding portion 11a) and a second winding portion 30 (secondary winding portion 11b) each wound around core 21.

First winding portion 29 includes a first coil pattern 37a and a first wiring body 45a. Second winding portion 30 includes a second coil pattern 37b and a second wiring body 45b. First coil pattern 37a and second coil pattern 37b are formed in a metal base substrate 31. First wiring body 45a and second wiring body 45b are formed in a wiring member 41. First winding portion 29 and second winding portion 30 are electrically insulated from each other. Metal base substrate 31 is placed on a first cooling body 39a as a cooling body 39.

The structure of coil device 20 will be specifically described. Transformer 11 includes metal base substrate 31, wiring member 41, core 21, and first cooling body 39a. First, core 21 is composed of an E-shaped core 23 and an I-shaped core 25. E-shaped core 23 has a leg portion 23a, a leg portion 23b, and a leg portion 23c. As I-shaped core 25 abut on leg portion 23a, leg portion 23b, and leg portion 23c, core 21 having a loop-shaped magnetic path is formed. E-shaped core 23 and I-shaped core 25 are fixed to each other with an adhesive (not shown).

As core 21 (E-shaped core 23 and I-shaped core 25), for example, a ferrite core such as a manganese zinc (Mn—Zn)-based ferrite core or a nickel zinc (Ni—Zn)-based ferrite core is used. In addition, an amorphous core or an iron dust core may be used as core 21.

The structure of core 21 is a combination of E-shaped core 23 and I-shaped core 25, but core 21 is not limited to E-shaped core 23 and I-shaped core 25 as long as core 21 having a loop-shaped magnetic path can be formed by a combination of cores. For example, core 21 may be a core formed of two U-shaped cores combined. It may also be a core formed of two E-shaped cores combined. Further, it may be a core formed of a T-shaped core and a U-shaped core combined.

Metal base substrate 31 is composed of a metal base body 34, an insulating layer 35, and a coil pattern 37. In metal base substrate 31, coil pattern 37 is disposed on metal base body 34 with insulating layer 35 interposed in between. Metal base body 34 has a thermal conductivity of 1.0 W/(m·K) or more, preferably 10.0 W/(m·K) or more, and more preferably 100.0 W/(m·K) or more. Metal base body 34 is formed of, for example, a metal material such as copper, iron, aluminum, iron alloy, or aluminum alloy.

Metal base substrate 31 includes a first metal base substrate 31a and a second metal base substrate 31b. First metal base substrate 31a includes a first extending portion 33a extending from the outer region of core 21 to the inner region of core 21. Second metal base substrate 31b includes a second extending portion 33b extending from the outer region of core 21 to the inner region of core 21.

First metal base substrate 31a and second metal base substrate 31b are disposed such that first extending portion 33a and second extending portion 33b face each other in such a manner that an insertion portion 32, through which leg portions 23a to 23c of core 21 are inserted, is formed between first metal base substrate 31a and second metal base substrate 31b. Insertion portion 32 includes an insertion portion 32a through which leg portion 23a is inserted, an insertion portion 32b through which leg portion 23b is inserted, and an insertion portion 32c through which leg portion 23c is inserted.

A slit portion 27 that prevents a flow of a loop-shaped induced current is formed in the portion of metal base substrate 31 which surrounds core 21. Slit portion 27 is formed in the inner region of core 21. Slit portion 27 is formed so as to be connected to insertion portion 32. First extending portion 33a (first metal base substrate 31a) and second extending portion 33b (second metal base substrate 31b) are disposed with a length SL, which corresponds to slit portion 27, in between.

Slit portion 27 physically and electrically separates the portions of first metal base substrate 31a and second metal base substrate 31b, which surround leg portion 23a, from each other. Slit portion 27 has the function of preventing formation of a short coil in metal base body 34. This will be described later.

Insulating layer 35 has a first main surface 35a and a second main surface 35b. Second main surface 35b is in contact with almost the entire metal base body 33. Insulating layer 35 has electrical insulation. Insulating layer 35 is formed of, for example, an epoxy resin, a glass-fiber-reinforced epoxy resin, a polyimide resin, or the like. In addition, thermally conductive fillers may be mixed into the epoxy resin or the like to improve thermal conductivity.

The thickness of insulating layer 35 is preferably as thin as possible within the range that does not affect electrical insulation or manufacturability. The thickness of insulating layer 35 is set to, for example, a thickness of about 1 μm or more and 2000 μm or less. More preferably, the thickness of insulating layer 35 is set to a thickness of about 1 μm or more and 200 μm or less. Insertion portion 32a through which leg portion 23a of E-shaped core 23 is inserted, insertion portion 32b through which leg portion 23b is inserted, and insertion portion 32c through which leg portion 23c is inserted are formed in insulating layer 35.

Coil pattern 37 is formed on first main surface 35a of insulating layer 35. Coil pattern 37 includes first coil pattern 37a and second coil pattern 37b. First coil pattern 37a is formed in first metal base substrate 31a. Second coil pattern 37b is formed in second metal base substrate 31b.

First coil pattern 37a includes a first-coil-pattern first portion 37af and a first-coil-pattern second portion 37as. Inverter circuit unit 2 is formed on first metal base substrate 31a. First-coil-pattern first portion 37af and first-coil-pattern second portion 37as are electrically connected to inverter circuit unit 2. A wiring pattern (not shown) other than first coil pattern 37a may be formed in first metal base substrate 31a.

Second coil pattern 37b includes a second-coil-pattern first portion 37bf and a second-coil-pattern second portion 37bs. Rectifier circuit unit 4 is formed on second metal base substrate 31b. Second-coil-pattern first portion 37bf and second-coil-pattern second portion 37bs are electrically connected to rectifier circuit unit 4. A wiring pattern (not shown) other than second coil pattern 37b may be formed in second metal base substrate 31b.

First metal base substrate 31a with first coil pattern 37a and inverter circuit unit 2 electrically has a primary-side potential. Second metal base substrate 31b with second coil pattern 37b and rectifier circuit unit 4 electrically has a secondary-side potential. First metal base substrate 31a having the primary-side potential and second metal base substrate 31b having the secondary-side potential are electrically insulated from each other.

The thicknesses of first coil pattern 37a and second coil pattern 37b (coil pattern 37), and the like are, for example, about 1 μm or more and 2000 μm or less. First coil pattern 37a, second coil pattern 37b, and the like are formed of, for example, copper, nickel, gold, aluminum, silver, tin, or the like. Coil pattern 37 and the like may also be formed of an alloy containing these metals.

The heat generated in coil pattern 37 is dissipated to metal base body 34 via insulating layer 35 that is in contact with almost the entire metal base body 34. By setting the thickness of insulating layer 35 as thin as possible within the range that does not affect both electrical insulation and manufacturability, the heat dissipation of the heat dissipation path can be increased.

First coil pattern 37a and metal base body 34 are separated from each other with a creepage distance CR1 in between. When the potential of first coil pattern 37a is different from the potential of metal base body 34, securing creepage distance CR1 prevents insulation breakdown from occurring in a creepage surface between first coil pattern 37a and metal base body 34.

Creepage distance CR1 is set based on the potential difference between the potential of first coil pattern 37a and the potential of metal base body 34. As the potential difference increases, creepage distance CR1 needs to be set larger. From the perspective of preventing insulation breakdown, a rounded pattern is preferably disposed as first coil pattern 37a so as not to become sharp at a corner or the like. In addition, second coil pattern 37b and metal base body 34 are separated from each other with a creepage distance CR2 in between. Creepage distance CR2 is set similarly to creepage distance CR1.

Wiring member 41 is disposed so as to straddle first metal base substrate 31a and second metal base substrate 31b that face each other with slit portion 27 in between. Wiring member 41 includes an insulating portion 43 and a wiring body 45. Wiring member 41 has an insertion portion 42. As insertion portion 42, an insertion portion 42a, through which leg portion 23a of E-shaped core 23 is inserted, an insertion portion 42b, through which leg portion 23b is inserted, and an insertion portion 42c, through which leg portion 23c is inserted, are formed. A printed wiring board is used as wiring member 41. As wiring member 41, for example, a metal bus bar covered with an insulating coating or the like may be used in addition to the printed circuit board.

Insulating portion 43 has a first main surface 43a and a second main surface 43b. Wiring body 45 includes first wiring body 45a and second wiring body 45b.

First wiring body 45a and second wiring body 45b are formed of, for example, copper, nickel, gold, aluminum, silver, tin, or the like. First wiring body 45a is formed on first main surface 43a of insulating portion 43. First wiring body 45a is disposed to surround insertion portion 42a. Second wiring body 45b is formed on second main surface 43b of insulating portion 43. Second wiring body 45b is disposed to surround insertion portion 42a.

One end side of first wiring body 45a is electrically connected to first-coil-pattern first portion 37af via a through hole conductive portion 47 and an electrically conductive bonding member 53. The other end side of first wiring body 45a is electrically connected to first-coil-pattern second portion 37as via through hole conductive portion 47 and electrically conductive bonding member 53. One end side of second wiring body 45b is electrically connected to second-coil-pattern first portion 37bf via electrically conductive bonding member 53. The other end side of second wiring body 45b is electrically connected to second-coil-pattern second portion 37bs via electrically conductive bonding member 53.

For example, an electrically conductive adhesive, solder, or the like can be used as bonding member 53. First wiring body 45a is thermally bonded to first metal base substrate 31a via bonding member 53 for thermal conduction. Second wiring body 45b is thermally bonded to second metal base substrate 31b via bonding member 53 for thermal conduction.

In addition, a thermally conductive member (not shown) may be further interposed between wiring body 45 and coil pattern 37. Consequently, wiring body 45 and coil pattern 37 are thermally bonded for thermal conduction via the thermally conductive member in addition to bonding member 53. For example, the thermal conductivity of the thermally conductive member is preferably 0.1 W/(m·K) or more, more preferably 1.0 W/(m·K) or more, and still more preferably 10.0 W/(m·K) or more. As the thermally conductive member, for example, a thermally conductive grease, a thermally conductive sheet, a thermally conductive adhesive, or the like can be used.

Insulating portion 43 has electrical insulation. Insulating portion 43 is formed of, for example, a glass-fiber-reinforced epoxy resin, a phenol resin, polyphenylene sulfide (PPS), polyetheretherketone (PEEK), or the like.

As described above, the printed circuit board used as wiring member 41 may be formed of a material that is generally considered to have a relatively low thermal conductivity. In other words, the printed circuit board used as wiring member 41 may be a general-purpose printed circuit board. In addition, a ceramic substrate of aluminum oxide, aluminum nitride, silicon carbide, or the like may be used as the printed circuit board used as wiring member 41. A thermally conductive portion (not shown) may be formed on the surface of, or inside of, wiring member 41.

In addition, as wiring member 41, for example, a laminated bus bar obtained by laminating an insulating film sheet and a metal conductor may be used. As the insulating film sheet, for example, a film formed of polyethylene terephthalate (PET), a film formed of polyimide (PI), or paper formed of aramid (wholly aromatic polyamide) fibers may be used. The insulating film sheet may be, for example, bonded to a metal conductor that turns into a wiring body by an adhesive layer or a cohesive layer.

Metal base substrate 31 with coil pattern 37 or the like formed therein is placed on first cooling body 39a. Metal base substrate 31 is fixed to first cooling body 39a, for example, with a screw (not shown). A groove portion 40, in which E-shaped core 23 is accommodated, is formed in a main surface 39aa of first cooling body 39a. For example, the thermal conductivity of first cooling body 39a is preferably 1.0 W/(m·K) or more, more preferably 10.0 W/(m·K) or more, and still more preferably 100.0 W/(m·K) or more.

First cooling body 39a is formed of, for example, a metal material such as copper, iron, aluminum, iron alloy, or aluminum alloy. First cooling body 39a may also be formed of, for example, a resin having a high thermal conductivity. First cooling body 39a may be electrically connected to any other member so as to have the same potential as the ground potential.

As metal base substrate 31 is in abutment with main surface 39aa of first cooling body 39a, first cooling body 39a and metal base substrate 31 are thermally coupled with each other for thermal conduction. Interposing a thermally conductive member (not shown) between main surface 39aa of first cooling body 39a and metal base substrate 31 further facilitates thermal conduction.

In addition, as E-shaped core 23 is in abutment with the bottom surface of groove portion 40 of first cooling body 39a, core 21 (E-shaped core 23) and first cooling body 39a are thermally coupled to each other for thermal conduction. Interposing a thermally conductive member (not shown) between the bottom surface of groove portion 40 and E-shaped core 23 further facilitates thermal conduction.

E-shaped core 23 and first cooling body 39a may be bonded to each other with an adhesive (not shown). First cooling body 39a may also form part of the housing of coil device 20. First cooling body 39a may also form part of the housing of power converter 1 including coil device 20. Further, in first cooling body 39a, the surface that is different from the surface on which metal base substrate 31 is disposed may be air-cooled or water-cooled. Coil device 20 (power converter 1) according to Embodiment 1 is configured as described above.

Next, the operation of the power converter (coil device 20, transformer 11) described above will be described briefly. First, it has been described that slit portion 27 in coil device 20 (transformer 11) has the function of preventing formation of a short coil in metal base body 34. This will be described.

As shown in the left diagram of FIG. 5, when no slit is provided in metal base body 34, the portions of metal base body 34 located to surround leg portion 23a, around which coil pattern 37 is wound, are physically and electrically connected to each other. Consequently, when a current flows between a terminal TA and a terminal TB in coil pattern 37, an induced current RP flows through the portions of metal base body 34 in a loop shape.

As shown in the right diagram of FIG. 5, induced current RP becomes a short coil that is magnetically coupled with coil pattern 37 in metal base body 34. As a result, coil device 20 (transformer 11) fails to exhibit desired performance. Thus, by providing slit portion 27 in metal base body 34, the flow of induced current RP is prevented, allowing transformer 11 to exhibit the desired performance.

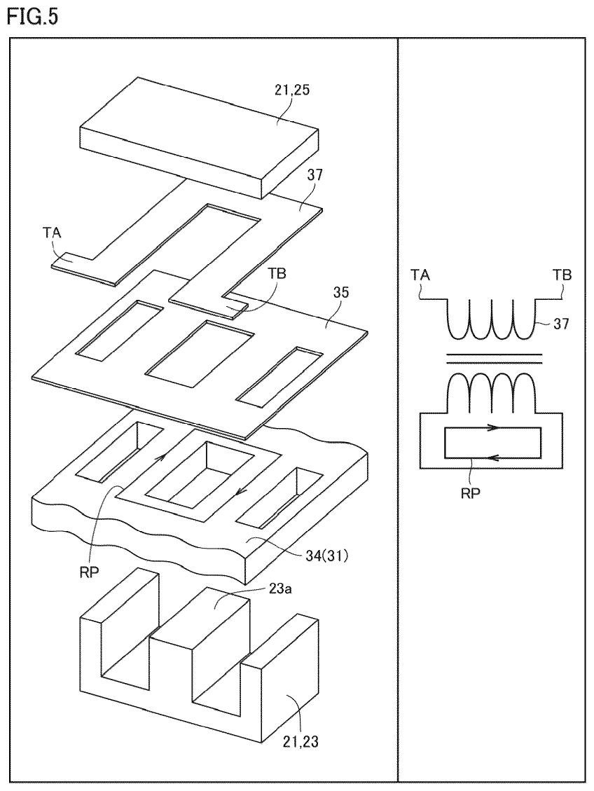

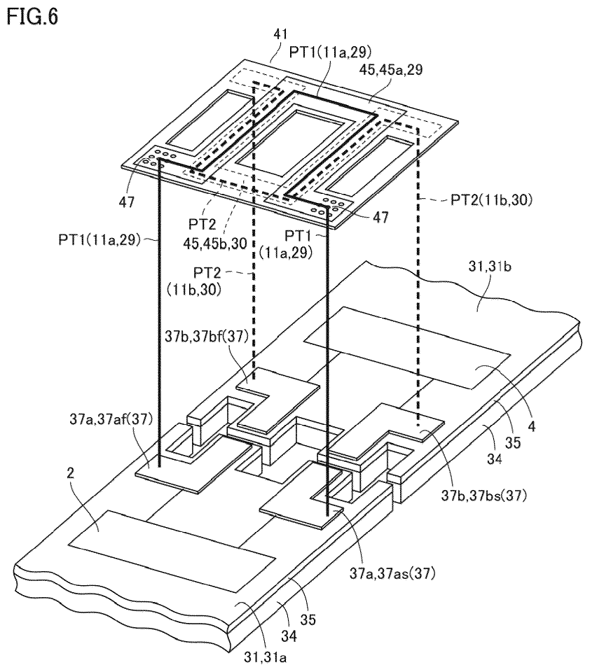

In power converter 1 including coil device 20 (transformer 11), an AC voltage converted in inverter circuit unit 2 is converted into an arbitrary voltage by transformer 11. At this time, as shown in FIG. 6, the AC voltage converted by inverter circuit unit 2 flows through a current path PT1. Current path PT1 is first winding portion 29, which includes first coil pattern 37a and first wiring body 45a. First winding portion 29 becomes primary winding portion 11a in transformer 11.

The AC voltage converted into an arbitrary voltage by transformer 11 flows through a current path PT2. Current path PT2 is second winding portion 30, which includes second coil pattern 37b and second wiring body 45b. Second winding portion 30 is secondary winding portion 11b in transformer 11. The AC voltage that has flowed through current path PT2 is converted into a DC voltage in rectifier circuit unit 4. In coil device 20 (transformer 11), primary winding portion 11a generates heat due to the AC voltage flowing through primary winding portion 11a. Secondary winding portion 11b also generates heat due to the AC voltage flowing through secondary winding portion 11b.

In coil device 20 described above, the heat generated in the portion of first winding portion 29 which is located in the outer region of core 21 is dissipated to first cooling body 39a via insulating layer 35 and metal base body 34. The heat generated in the portion of first winding portion 29 which is located in the inner region of core 21 is also dissipated to first cooling body 39a via insulating layer 35 and metal base body 34.

Thus, the heat generated in the portion of first winding portion 29 which is located in the inner region of core 21 can be dissipated to first cooling body 39a to the same extent as the heat generated in the portion of first winding portion 29 which is located in the outer region of core 21.

In the case of secondary winding portion 11b, as in the case of primary winding portion 11a, the heat generated in the portion of secondary winding portion 11b which is located in the outer region of core 21 is dissipated to first cooling body 39a via insulating layer 35 and metal base body 34. The heat generated in the portion of secondary winding portion 11b which is located in the inner region of core 21 is also dissipated to first cooling body 39a via insulating layer 35 and metal base body 34.

As a result, the heat generated in the portion of secondary winding portion 11b which is located in the inner region of core 21 can be dissipated to first cooling body 39a to the same extent as the heat generated in the portion of secondary winding portion 11b which is located in the outer region of core 21. As a result, the heat dissipation of coil device 20 can be improved. In addition, the need for increasing the sizes of first coil pattern 37a, second coil pattern 37b, and the like for heat dissipation can be eliminated, thus contributing to the miniaturization of coil device 20 and, in turn, the miniaturization of power converter 1.

In coil device 20 described above, metal base substrate 31 includes first metal base substrate 31a and second metal base substrate 31b. First metal base substrate 31a and second metal base substrate 31b are not an integrated metal base substrate, but are separate metal base substrates. Thus, the area per metal base substrate can be reduced compared to the case where first metal base substrate 31a and second metal base substrate 31b are formed of a single integrated metal base substrate.

Thus, warpage of metal base substrate 31 which is assumed to occur in manufacture of coil device 20 can be reduced. Also, the number of metal base bodies that can be extracted from a sheet-shaped metal base body can be optimized. This can contribute to a reduction in the manufacturing cost of the metal base substrate.

Further, forming first metal base substrate 31a and second metal base substrate 31b of separate metal base substrates as metal base substrate 31 allows metal base substrate 31 to be shared even when the input voltage to input terminal 6 is different in power converter 1. This will be described.

First, let Bm be a magnetic flux density of core 21 (leg portion 23a) shown in FIG. 2, Ton be a period during which switching element 9 of inverter circuit unit 2 is turned on, Vin be an input voltage to input terminal 6, N be the number of turns of first winding portion 29 (primary winding portion 11a) in coil device 20 (transformer 11), and Ae be a cross-sectional area of leg portion 23a in core 21 (E-shaped core 23), the relational expression Vin×Ton=Bm×N×Ae holds.

Herein, magnetic flux density Bm affects the heat generation of core 21. Thus, when input voltage Vin increases, magnetic flux density Bm also preferably has an equal value if the heat dissipation structure of core 21 is a similar structure. For example, it is assumed that input voltage Vin input to input terminal 6 of power converter 1 is tripled.

In this case, from the above relational expression, one of the following values needs to be selected: a value obtained by reducing period Ton, during which switching element 9 is turned on, to one-third, a value obtained by tripling number of turns N of first winding portion 29, and a value obtained by tripling cross-sectional area Ae of leg portion 23a. In addition, it is necessary to satisfy the above relational expression by combining an increase or a decrease in the value of period Ton, the value of number of turns N, and the value of cross-sectional area Ae.

When period Ton during which switching element 9 is turned on is reduced, both the amount of heat generated by switching element 9 in inverter circuit unit 2 and the amount of heat generated by rectifier element 12 in rectifier circuit unit 4 increase. Thus, when the heat dissipation structure of switching element 9 is equivalent to the heat dissipation structure of rectifier element 12, it is preferable that period Ton during which switching element 9 is turned on also be equivalent.

When number of turns N of first winding portion 29 (primary winding portion 11a) in wiring member 41 is increased, as metal base substrate 31, it is not necessary to change first metal base substrate 31a and second metal base substrate 31b, and it is only required to change wiring member 41. In this case, metal base substrate 31 may be configured of a single metal base substrate.

When cross-sectional area Ae of leg portion 23a is increased, it is sufficient to secure a spacing (length SL) between first metal base substrate 31a and second metal base substrate 31b such that insertion portion 32a (32), through which leg portion 23a of E-shaped core 23 is inserted, is formed, without changing first metal base substrate 31a and second metal base substrate 31b. In addition, it is sufficient to change wiring member 41 such that insertion portion 42a (42), through which leg portion 23a of E-shaped core 23 is inserted, is formed in wiring member 41.

The selectable design range of number of turns N of first winding portion 29 (primary winding portion 11a) in wiring member 41 is limited due to the constraints on the insulation distance and the wiring width. Thus, use of first metal base substrate 31a and second metal base substrate 31b as metal base substrate 31 can change cross-sectional area Ae of leg portion 23a of E-shaped core 23, and then expand the design range by combining number of turns N and cross-sectional area Ae.

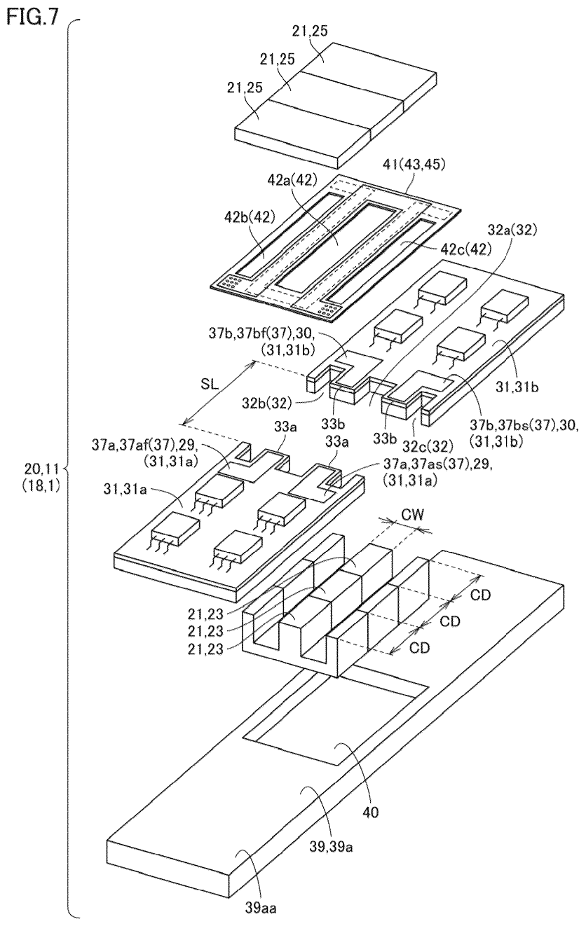

FIG. 7 shows an example of the structure of power converter 1 (coil device 20) when input voltage Vin input to input terminal 6 of power converter 1 is assumed to be tripled. In power converter 1 shown in FIG. 7, first metal base substrate 31a and second metal base substrate 31b are used as metal base substrate 31, and insertion portion 42 of wiring member 41 and cross-sectional area Ae of E-shaped core 23 are changed.

In power converter 1 shown in FIG. 7, cross-sectional area Ae (3·CD×CW) of E-shaped core 23 is three times larger than that of power converter 1 shown in FIG. 2. First metal base substrate 31a and second metal base substrate 31b are disposed with length SL in between such that insertion portion 32, through which E-shaped core 23 whose cross-sectional area Ae is increased threefold is inserted, is formed. In addition, the area of insertion portion 42 of wiring member 41 is increased threefold. When input voltage Vin is increased threefold, the relational expression described above can be said to hold due to the fact that cross-sectional area Ae is increased threefold.

When the electrical specifications of power converter 1 are changed, for example, when input voltage Vin is increased, the dimensions of wiring member 41 may be changed, the dimensions of first metal base substrate 31a and second metal base substrate 31b may not be changed, and first metal base substrate 31a and second metal base substrate 31b before the change can be used. As a result, first metal base substrate 31a and second metal base substrate 31b can be shared for changes in electrical specifications. This can contribute to a reduction in the manufacturing cost of metal base substrate 31.

Description has been given of the case where in power converter 1 described above, first wiring body 45a of first winding portion 29 is disposed on first main surface 43a in insulating portion 43 of wiring member 41, and second wiring body 45b of second winding portion 30 is disposed on second main surface 43b in insulating portion 43. For example, when the voltage of first winding portion 29 is higher than the voltage of second winding portion 30, the current flowing through second winding portion 30 is greater than the current flowing through first winding portion 29, and the amount of heat generated by second winding portion 30 is greater than the amount of heat generated by first winding portion 29.

Thus, it is preferable that second winding portion 30 be disposed on second main surface 43b in insulating portion 43, which is closer to second metal base substrate 31b, and first winding portion 29 having a relatively high voltage be disposed on first main surface 43a in insulating portion 43 for more reliable electrical insulation.

For coil device 20 of power converter 1 described above, the structure in which first winding portion 29 and second winding portion 30 are each wound one turn around leg portion 23a of E-shaped core 23 (number of turns: 1 (one turn)) has been described by way of example. Further, a single printed circuit board has been described by way of example as wiring member 41 in which first wiring body 45a and second wiring body 45b are disposed.

The number of turns of each of first winding portion 29 and second winding portion 30 may be two or more, depending on the specifications. To increase the number of turns, two or more printed circuit boards may be stacked as wiring member 41. When two or more printed circuit boards are stacked, one printed circuit board and the other printed circuit board may be electrically connected to each other by an electrically conductive bonding member. For example, a multilayer printed circuit board in which wiring bodies and insulating portions are alternately stacked may be used.

As described above, when the number of turns of each of first winding portion 29 and second winding portion 30 is increased, it is sufficient to stack printed circuit boards, and it is not necessary to increase the sizes of first metal base substrate 31a and second metal base substrate 31b. This can contribute to the miniaturization of coil device 20 and, in turn, the miniaturization of power converter 1.

### (Modification 1)

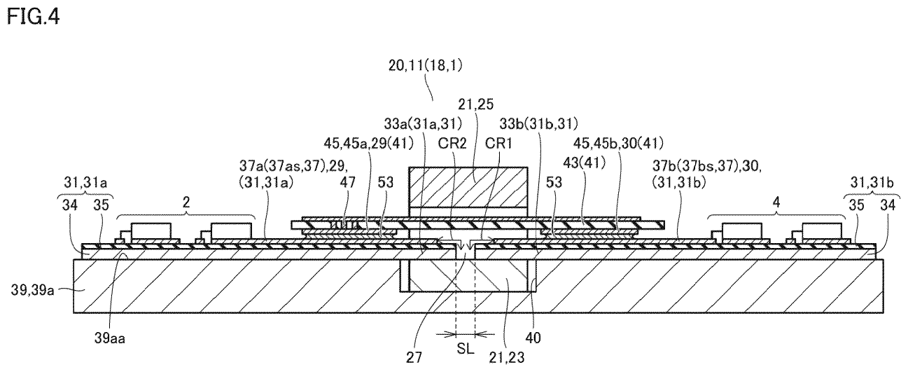

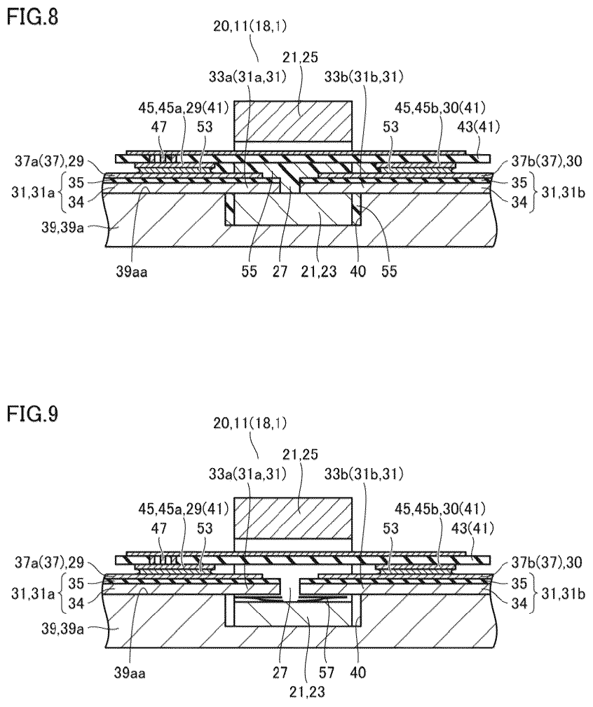

Coil device 20 (power converter 1) according to Modification 1 will be described. As shown in FIG. 8, in coil device 20, a sealing member 55 is charged between metal base substrate 31 and wiring member 41. In addition, sealing member 55 is charged between core 21 (E-shaped core 23) and first cooling body 39a (groove portion 40). The other components, which are the same as those of coil device 20 shown in FIG. 4, are denoted by the same reference signs, and description thereof will not be repeated unless necessary.

Sealing member 55 is preferably formed of a material having a thermal conductivity of about 0.1 W/(m·K) or more, and preferably about 1.0 W/(m·K). Sealing member 55 has electrical insulation. Sealing member 55 may have a Young's modulus of 1 MPa or more. Sealing member 55 may be formed of a resin material having elasticity. Sealing member 55 may be formed of an epoxy resin containing thermally conductive fillers. Sealing member 55 may be formed of a rubber material such as silicone or urethane.

As sealing member 55 described above is charged, the heat generated in metal base substrate 31 and the heat generated in wiring member 41 can be dissipated to first cooling body 39a via sealing member 55. This can eliminate the need for increasing the size of metal base substrate 31 or the like in order to dissipate heat from metal base substrate 31 and wiring member 41, thus further contributing to the miniaturization of coil device 20 and, in turn, the miniaturization of power converter 1.

Also, in general, it is necessary to secure a creepage distance of a certain length or more between electrically conductive materials having different potentials in order to prevent insulation breakdown between one electrically conductive material and the other electrically conductive material. In the event where there is a possible risk that the creepage surface between the one electrically conductive material and the other electrically conductive material may be contaminated by an electrically conductive substance, it is necessary to secure a longer creepage distance.

In coil device 20 according to Modification 1 described above, sealing member 55 is charged between metal base substrate 31 and wiring member 41, including between first metal base substrate 31a and second metal base substrate 31b. This can prevent the surface of metal base substrate 31 from being contaminated by the electrically conductive substance. As a result, both the creepage distance between first coil pattern 37a and metal base body 34 and the creepage distance between second coil pattern 37b and metal base body 34 can be reduced, thus contributing to the miniaturization of coil device 20 and, in turn, the miniaturization of power converter 1.

In addition, with E-shaped core 23 accommodated in groove portion 40 provided in first cooling body 39a, sealing member 55 is charged between groove portion 40 and E-shaped core 23. This allows the heat generated in core 21 to be dissipated to first cooling body 39a via sealing member 55. This can eliminate the need for increasing the size of core 21 for heat dissipation, thus further contributing to the miniaturization of coil device 20 and, in turn, the miniaturization of power converter 1.

Further, sealing member 55 fixes wiring member 41 to metal base substrate 31, and fixes core 21 (E-shaped core 23) to first cooling body 39a. As a result, the vibration resistance of coil device 20 and, in turn, the vibration resistance of power converter 1 can be improved.

### (Modification 2)

Coil device 20 (power converter 1) according to Modification 2 will be described. As shown in FIG. 9, in coil device 20, an elastic member 57 such as a spring is interposed between metal base substrate 31 and E-shaped core 23 as a biasing member. The other components, which are the same as those of coil device 20 shown in FIG. 4, are denoted by the same reference signs, and description thereof will not be repeated unless necessary.

In coil device 20 according to Modification 2 described above, elastic member 57 is interposed between metal base substrate 31 and E-shaped core 23. Consequently, the heat generated in E-shaped core 23 (core 21) is efficiently conducted to metal base substrate 31 (first metal base substrate 31a and second metal base substrate 31b) via elastic member 57 such as a spring, and the heat conducted to metal base substrate 31 (metal base body 34) is dissipated to first cooling body 39a. This can eliminate the need for increasing the size of core 21 for heat dissipation, thus further contributing to the miniaturization of coil device 20 and, in turn, the miniaturization of power converter 1.

In addition, E-shaped core 23 (core 21) is biased against first cooling body 39a by elastic member 57 interposed between metal base substrate 31 and E-shaped core 23. As a result, the vibration resistance of coil device 20 and, in turn, the vibration resistance of power converter 1 can be improved.

### (Modification 3)

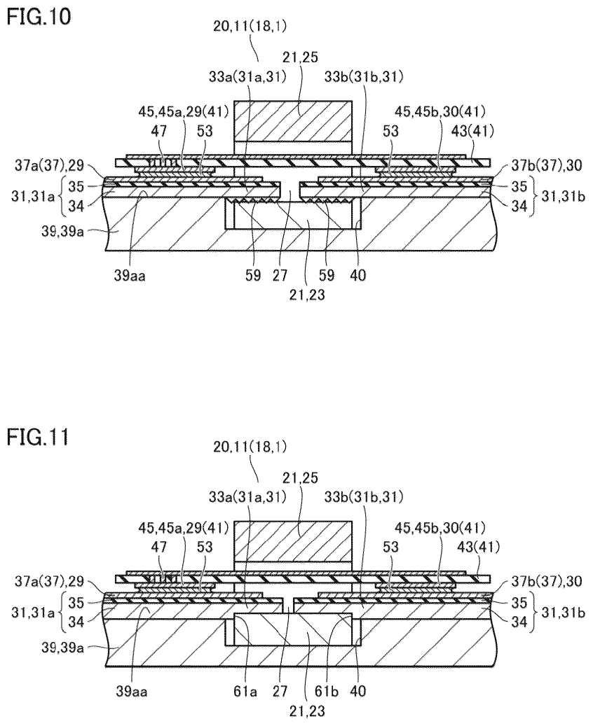

Coil device 20 (power converter 1) according to Modification 3 will be described. As shown in FIG. 10, in coil device 20, a protruding and recessed portion 59 is formed on metal base substrate 31 as a biasing member. Protruding and recessed portion 59 is interposed between metal base substrate 31 and E-shaped core 23. Burrs that occur in production of metal base substrate 31 are used as protruding and recessed portion 59. One example of processing the outer shape of metal base substrate 31 (metal base body 34) is pressing.

In pressing, metal base substrate 31 is processed by applying pressure to metal base substrate 31 (metal base body 34) using a die. During the pressing, burrs are generated in metal base body 34. The burrs are generated to protrude from the surface of metal base substrate 31. For example, the burrs are generated such that protruding portions and recessed portions are alternately contiguous to each other.

In this coil device 20, the burrs generated by pressing are interposed between metal base substrate 31 and E-shaped core 23 (core 21) as protruding and recessed portion 59. The other components, which are the same as those of coil device 20 shown in FIG. 4, are denoted by the same reference signs, and description thereof will not be repeated unless necessary.

In coil device 20 according to Modification 3 described above, the burrs generated in metal base substrate 31 in association with pressing are interposed between metal base substrate 31 and E-shaped core 23 as protruding and recessed portion 59. As a result, E-shaped core 23 (core 21) is biased against first cooling body 39a by protruding and recessed portion 59 interposed between metal base substrate 31 and E-shaped core 23.

Further, the protruding portion of protruding and recessed portion 59, which is burrs, has a sharp shape. This restricts the movement of E-shaped core 23 (21) in a direction intersecting the direction in which E-shaped core 23 (core 21) is biased toward first cooling body 39a. As a result, the vibration resistance of coil device 20 and, in turn, the vibration resistance of power converter 1 can be further improved.

In addition, as E-shaped core 23 (core 21) is biased against first cooling body 39a by protruding and recessed portion 59, the heat generated in core 21 can be efficiently dissipated to first cooling body 39a. This can eliminate the need for increasing the size of core 21 for heat dissipation, thus further contributing to the miniaturization of coil device 20 and, in turn, the miniaturization of power converter 1.

### Embodiment 2

Embodiment 2 will describe a second example of the transformer as a coil device. As shown in FIG. 11, a stepped portion 61a and a stepped portion 61b as retaining portions that retain E-shaped core 23 (core 21) in between are formed in metal base substrate 31.

First extending portion 33a in first metal base substrate 31a and second extending portion 33b in second metal base substrate 31b face each other with slit portion 27 in between. Stepped portion 61a is formed in first extending portion 33a of first extending portion 33a and second extending portion 33b facing each other. Stepped portion 61b is formed in second extending portion 33b of first extending portion 33a and second extending portion 33b facing each other.

With one end of E-shaped core 23 received in stepped portion 61a and the other end of E-shaped core 23 received in stepped portion 61b, E-shaped core 23 is retained between stepped portion 61a (first extending portion 33a) and stepped portion 61b (second extending portion 33b), and is also biased against first cooling body 39a. The other components, which are the same as those of coil device 20 shown in FIG. 4, are denoted by the same reference signs, and description thereof will not be repeated unless necessary.

In coil device 20 described above, E-shaped core 23 is retained between stepped portion 61a in first extending portion 33a and stepped portion 61b in second extending portion 33b, and is also biased against first cooling body 39a. This restricts the movement of E-shaped core 23. As a result, the vibration resistance of coil device 20 and, in turn, the vibration resistance of power converter 1 can be improved.

In addition, since E-shaped core 23 is received in stepped portion 61a, the area of contact between E-shaped core 23 and first metal base substrate 31a (first extending portion 33a) increases. Since E-shaped core 23 is received in stepped portion 61b, the area of contact between E-shaped core 23 and second metal base substrate 31b (second extending portion 33b) increases.

As a result, the heat generated in E-shaped core 23 (core 21) is efficiently conducted to metal base substrate 31 (first metal base substrate 31a and second metal base substrate 31b), and the heat conducted to metal base substrate 31 (metal base body 34) is dissipated to first cooling body 39a. This can eliminate the need for increasing the size of core 21 for heat dissipation, thus further contributing to the miniaturization of coil device 20 and, in turn, the miniaturization of power converter 1.

### (Modification 1)

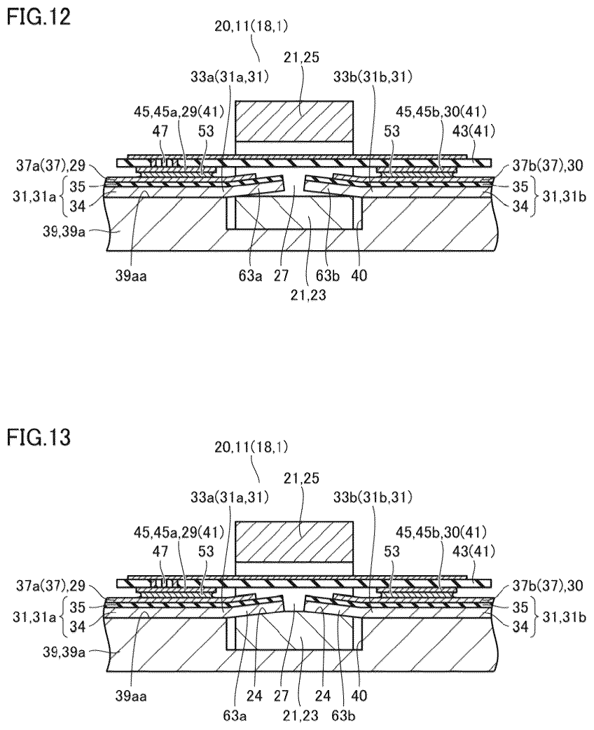

Coil device 20 (power converter 1) according to Modification 1 will be described. As shown in FIG. 12, an upward warped portion 63a, which is warped upward from E-shaped core 23 toward wiring member 41, is formed in first extending portion 33a in first metal base substrate 31a. In second extending portion 33b in second metal base substrate 31b, an upward warped portion 63b, which is warped upward from E-shaped core 23 toward wiring member 41, is formed.

The thickness of E-shaped core 23 is set to a thickness greater than or equal to a thickness corresponding to the depth of groove portion 40, and upward warped portion 63a and upward warped portion 63b are configured to abut on E-shaped core 23. The other components, which are the same as those of coil device 20 shown in FIG. 4, are denoted by the same reference signs, and description thereof will not be repeated unless necessary.

In coil device 20 according to Modification 1 described above, E-shaped core 23 is retained between first metal base substrate 31a (upward warped portion 63a) and first cooling body 39a, and E-shaped core 23 is retained between second metal base substrate 31b (upward warped portion 63b) and first cooling body 39a. At this time, E-shaped core 23 is biased against first cooling body 39a by upward warped portion 63a and upward warped portion 63b, so that E-shaped core 23 (core 21) is fixed to first cooling body 39a. This can eliminate the need for a fixing member that fixes E-shaped core 23 (core 21) to first cooling body 39a, thus contributing to a reduction in manufacturing cost.

In addition, E-shaped core 23 is biased against first cooling body 39a by upward warped portion 63a and upward warped portion 63b, thus improving the vibration resistance of coil device 20 and, in turn, the vibration resistance of power converter 1. Further, as E-shaped core 23 is biased against first cooling body 39a by upward warped portion 63a and upward warped portion 63b, the heat generated in E-shaped core 23 (core 21) can be efficiently dissipated to first cooling body 39a.

As shown in FIG. 13, inclined portions 24 may be provided along upward warped portion 63a and upward warped portion 63b at the portions of E-shaped core 23 on which upward warped portion 63a and upward warped portion 63b abut, respectively. As inclined portions 24 are provided in E-shaped core 23, the area of contact between E-shaped core 23 and each of first metal base substrate 31a and second metal base substrate 31b can be increased.

Thus, the heat generated in E-shaped core 23 (core 21) can be efficiently conducted to metal base substrate 31, and the heat conducted to metal base substrate 31 can be dissipated to first cooling body 39a. This can eliminate the need for increasing the size of core 21 for heat dissipation, thus further contributing to the miniaturization of coil device 20 and, in turn, the miniaturization of power converter 1.

### (Modification 2)

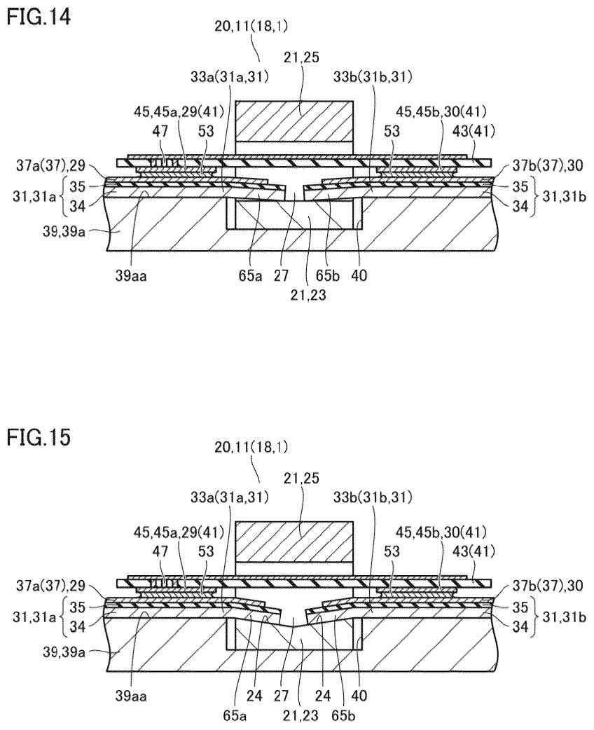

Coil device 20 (power converter 1) according to Modification 2 will be described. As shown in FIG. 14, a downward warped portion 65a, which is warped downward from first cooling body 39a toward E-shaped core 23, is formed in first extending portion 33a in first metal base substrate 31a. In second extending portion 33b in second metal base substrate 31b, a downward warped portion 65b, which is warped downward from first cooling body 39a toward E-shaped core 23, is formed.

The thickness of E-shaped core 23 is set to a thickness less than or equal to a thickness corresponding to the depth of groove portion 40, and downward warped portion 65a and downward warped portion 65b are configured to abut on E-shaped core 23. The other components, which are the same as those of coil device 20 shown in FIG. 4, are denoted by the same reference signs, and description thereof will not be repeated unless necessary.

In coil device 20 according to Modification 2 described above, E-shaped core 23 is retained between first metal base substrate 31a (downward warped portion 65a) and first cooling body 39a, and E-shaped core 23 is retained between second metal base substrate 31b (downward warped portion 65b) and first cooling body 39a. At this time, E-shaped core 23 is biased against first cooling body 39a by downward warped portion 65a and downward warped portion 65b, and E-shaped core 23 (core 21) is fixed to first cooling body 39a. This can eliminate the need for a fixing member that fixes E-shaped core 23 (core 21) to first cooling body 39a, thus contributing to a reduction in manufacturing cost.

In addition, E-shaped core 23 is biased against first cooling body 39a by downward warped portion 65a and downward warped portion 65b, thus improving the vibration resistance of coil device 20 and, in turn, the vibration resistance of power converter 1. Further, as E-shaped core 23 is biased against first cooling body 39a by downward warped portion 65a and downward warped portion 65b, the heat generated in E-shaped core 23 (core 21) can be efficiently dissipated to first cooling body 39a.

As shown in FIG. 15, inclined portions 24 may be provided along downward warped portion 65a and downward warped portion 65b at the portions of E-shaped core 23 on which downward warped portion 65a and downward warped portion 65b abut, respectively. As inclined portions 24 are provided in E-shaped core 23, the area of contact between E-shaped core 23 and each of first metal base substrate 31a and second metal base substrate 31b can be increased.

Thus, the heat generated in E-shaped core 23 (core 21) can be efficiently conducted to metal base substrate 31, and the heat conducted to metal base substrate 31 can be dissipated to first cooling body 39a. This can eliminate the need for increasing the size of core 21 for heat dissipation, thus further contributing to the miniaturization of coil device 20 and, in turn, the miniaturization of power converter 1.

### Embodiment 3

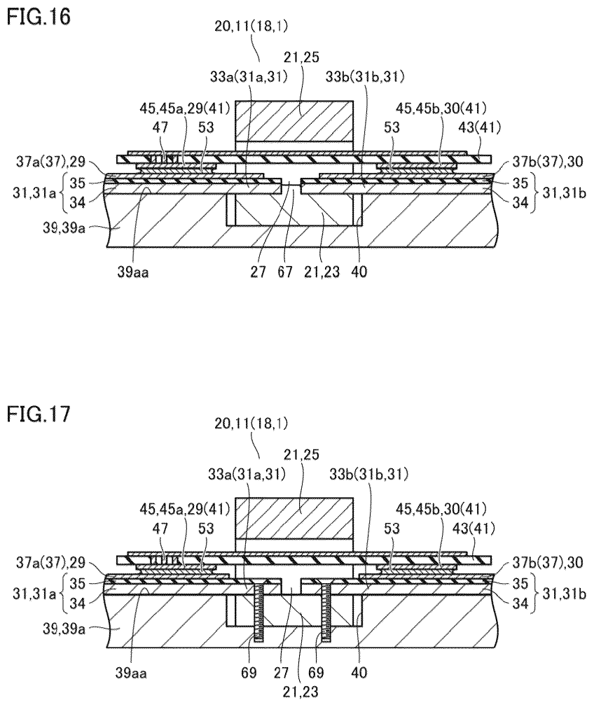

Embodiment 3 will describe a third example of the transformer as a coil device. As shown in FIG. 16, a protruding portion 67, which protrudes toward slit portion 27, is formed in E-shaped core 23. Protruding portion 67 is retained between first extending portion 33a (first metal base substrate 31a) and second extending portion 33b (second metal base substrate 31b). The other components, which are the same as those of coil device 20 shown in FIG. 4, are denoted by the same reference signs, and description thereof will not be repeated unless necessary.

In coil device 20 described above, protruding portion 67 protruding toward slit portion 27 is formed in E-shaped core 23. This causes E-shaped core 23 to be pressed against first cooling body 39a with core 21 (E-shaped core 23) retained between first metal base substrate 31a and second metal base substrate 31b. This can improve the vibration resistance of coil device 20 and, in turn, the vibration resistance of power converter 1.

In addition, as protruding portion 67 provided in E-shaped core 23 is retained between first metal base substrate 31a and second metal base substrate 31b, the area of contact between E-shaped core 23 and each of first metal base substrate 31a and second metal base substrate 31b can be increased.

Thus, the heat generated in E-shaped core 23 (core 21) can be efficiently conducted to metal base substrate 31, and the heat conducted to metal base substrate 31 can be dissipated to first cooling body 39a. This can eliminate the need for increasing the size of core 21 for heat dissipation, thus further contributing to the miniaturization of coil device 20 and, in turn, the miniaturization of power converter 1.

### Embodiment 4

Embodiment 4 will describe a fourth example of the transformer as a coil device. As shown in FIG. 17, a screw member 69, which passes through first extending portion 33a (first metal base substrate 31a) and E-shaped core 23 to reach first cooling body 39a, is attached as a first fixing member. A screw member 69, which passes through second extending portion 33b (second metal base substrate 31b) and E-shaped core 23 to reach first cooling body 39a, is attached as the first fixing member. The other components, which are the same as those of coil device 20 shown in FIG. 4, are denoted by the same reference signs, and description thereof will not be repeated unless necessary.

In coil device 20 described above, first metal base substrate 31a, second metal base substrate 31b, and E-shaped core 23 are fixed to first cooling body 39a with screw members 69. This can improve the vibration resistance of coil device 20 and, in turn, the vibration resistance of power converter 1.

In addition, the heat generated in core 21 (E-shaped core 23) is efficiently conducted to first metal base substrate 31a and second metal base substrate 31b (metal base substrate 31) via screw members 69, and the heat conducted to metal base substrate 31 is dissipated to first cooling body 39a. This can eliminate the need for increasing the size of core 21 for heat dissipation, thus further contributing to the miniaturization of coil device 20 and, in turn, the miniaturization of power converter 1.

### (Modification)

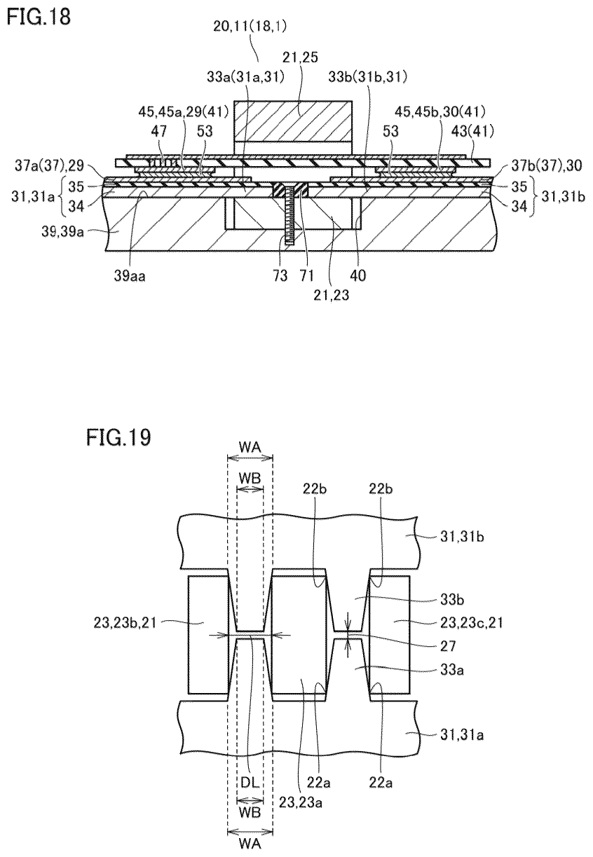

Coil device 20 (power converter) according to a modification will be described. As shown in FIG. 18, an insulating member 71 is charged between first metal base substrate 31a (first extending portion 33a) and second metal base substrate 31b (second extending portion 33b). A screw member 73, which passes through insulating member 71 and E-shaped core 23 to reach first cooling body 39a, is attached as a second fixing member. The other components, which are the same as those of coil device 20 shown in FIG. 4, are denoted by the same reference signs, and description thereof will not be repeated unless necessary.

In coil device 20 according to the modification described above, insulating member 71 and E-shaped core 23 interposed between first extending portion 33a and second extending portion 33b are fixed to first cooling body 39a with screw member 73. This can improve the vibration resistance of coil device 20 and, in turn, the vibration resistance of power converter 1. In addition, as E-shaped core 23 is pressed against first cooling body 39a, the heat generated in core 21 can be efficiently dissipated to first cooling body 39a.

It suffices that insulating member 71 is formed of any material that has electrical insulation. This can more effectively prevent insulation breakdown from occurring in the region between first metal base substrate 31a and second metal base substrate 31b.

### Embodiment 5

Embodiment 5 will describe a fifth example of the transformer as a coil device. As shown in FIG. 19, first extending portion 33a (first metal base substrate 31a) is formed to have a width gradually decreasing from the outer region of core 21 toward the inner region of core 21. Second extending portion 33b (second metal base substrate 31b) is formed to have a width gradually decreasing from the outer region of core 21 toward the inner region of core 21. The other components, which are the same as those of coil device 20 shown in FIG. 4, are denoted by the same reference signs, and description thereof will not be repeated unless necessary.

In coil device 20 described above, the portion (root portion) of each of first extending portion 33a and second extending portion 33b which is located in the outer region of core 21 has a width WA. In addition, the tip (inner region of core 21) of each of first extending portion 33a and second extending portion 33b has a width WB. In E-shaped core 23, the spacing between adjacent leg portion 23a and leg portion 23b (or leg portion 23c) is a spacing DL. Width WA is set to be larger than spacing DL. Width WB is set to be smaller than spacing DL.

Thus, one first extending portion 33a abuts on a corner 22a of each of leg portion 23a and leg portion 23b. The other first extending portion 33a abuts on corner 22a of each of leg portion 23a and leg portion 23c. In addition, one second extending portion 33b abuts on a corner 22b of each of leg portion 23a and leg portion 23b. The other second extending portion 33b abuts on corner 22b of each of leg portion 23a and leg portion 23c.

As first extending portion 33a abuts on corner 22a of E-shaped core 23, and second extending portion 33b abuts on corner 22b of the E-shaped core 23, core 21 (E-shaped core 23) is retained between first extending portion 33a and second extending portion 33b. As a result, the vibration resistance of coil device 20 and, in turn, the vibration resistance of power converter 1 can be improved.

### (Modification 1)

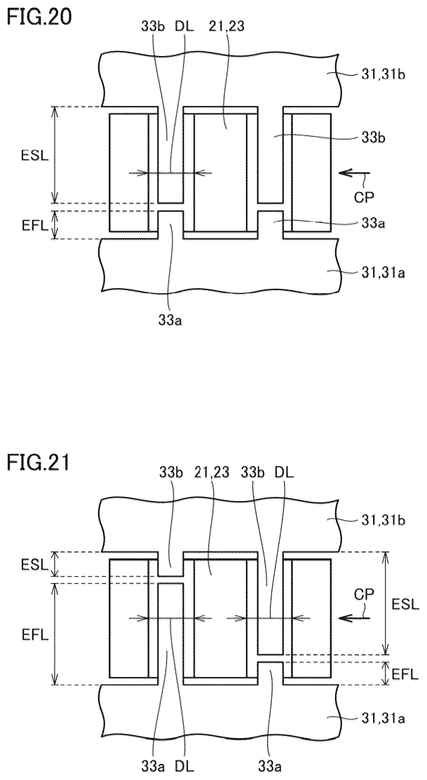

Modification 1 will be described. As shown in FIG. 20, first extending portion 33a has a length EFL from the outer region toward the inner region of core 21. Second extending portion 33b has a length ESL from the outer region toward the inner region of core 21. Length EFL of each of the two first extending portions 33a is smaller than length ESL of each of the two second extending portions 33b. Two second extending portions 33b, each of which has length ESL, extend beyond a central portion CP (extension direction) of core 21 to be located in the inner region of core 21.

In coil device 20 according to Modification 1, two second extending portions 33b in second metal base substrate 31b extend beyond central portion CP of core 21. This allows the heat generated near central portion CP in core 21, where the amount of heat generation is the greatest, to be efficiently conducted to second metal base substrate 31b via the two second extending portions 33b. The heat conducted to second metal base substrate 31b is dissipated to first cooling body 39a.

Two first extending portions 33a in first metal base substrate 31a may be positioned to extend beyond central portion CP of core 21. In this case, the heat generated near central portion CP in core 21, where the amount of heat generation is the greatest, is efficiently conducted to first metal base substrate 31a via two first extending portions 33a. The heat conducted to first metal base substrate 31a is dissipated to first cooling body 39a.

### (Modification 2)

Coil device 20 (power converter) according to Modification 2 will be described. As shown in FIG. 21, first extending portion 33a has length EFL from the outer region toward the inner region of core 21. Second extending portion 33b has length ESL from the outer region toward the inner region of core 21. Length EFL of one first extending portion 33a is larger than length ESL of one second extending portion 33b. Length EFL of the other first extending portion 33a is smaller than length ESL of the other second extending portion 33b. One first extending portion 33a having length EFL extends beyond central portion CP (extension direction) of core 21 to be located in the inner region of core 21. The other second extending portion 33b having length ESL extends beyond central portion CP (extension direction) of core 21 to be located in the inner region of core 21.

In coil device 20 according to Modification 2, one first extending portion 33a in first metal base substrate 31a extends beyond central portion CP of core 21. In addition, the other second extending portion 33b in second metal base substrate 31b extends beyond central portion CP of core 21. This allows the heat generated near central portion CP in core 21, where the amount of heat generation is the greatest, to be efficiently conducted to first metal base substrate 31a via one first extending portion 33a, and is also efficiently conducted to second metal base substrate 31b via the other second extending portion 33b. The heat conducted to each of first metal base substrate 31a and second metal base substrate 31b is dissipated to first cooling body 39a.

### Embodiment 6

Embodiment 6 will describe a sixth example of the transformer as a coil device. Herein, description will be given using the X-Y-Z Cartesian coordinate system as necessary. In addition, the components, which are the same as those of coil device 20 shown in FIG. 4, are denoted by the same reference signs, and description thereof will not be repeated unless necessary.

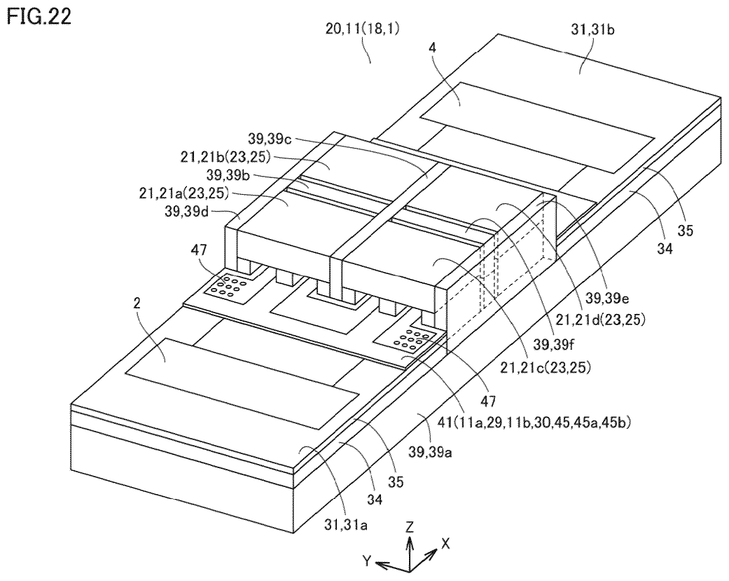

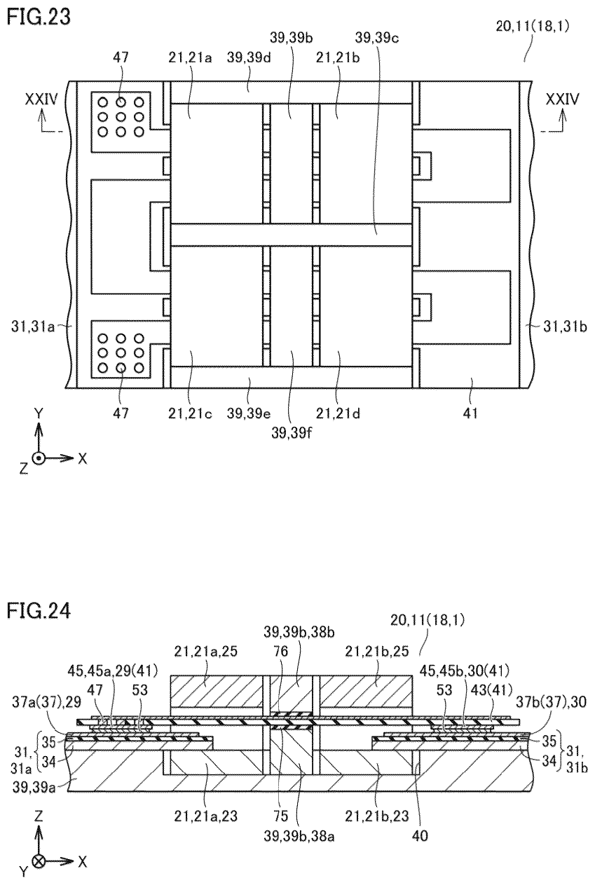

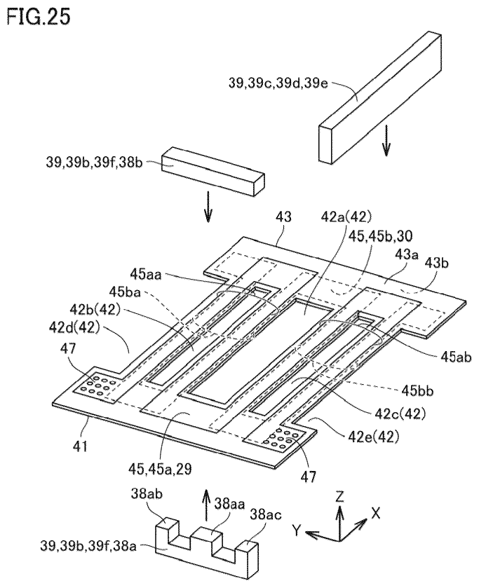

As shown in FIGS. 22, 23, 24, and 25, transformer 11 as coil device 20 includes a first core 21a, a second core 21b, a third core 21c, and a fourth core 21d as core 21. Transformer 11 includes a second cooling body 39b, a third cooling body 39c, a fourth cooling body 39d, a fifth cooling body 39e, and a sixth cooling body 39f as cooling body 39 in addition to first cooling body 39a. Second cooling body 39b, third cooling body 39c, fourth cooling body 39d, fifth cooling body 39e, and sixth cooling body 39f are each placed on first cooling body 39a. Second cooling body 39b to sixth cooling body 39f are thermally bonded to first cooling body 39a.

First wiring body 45a includes a first-wiring-body first portion 45aa and a first-wiring-body second portion 45ab. Each of first-wiring-body first portion 45aa and first-wiring-body second portion 45ab includes a portion extending along the X axis as the first direction. Second wiring body 45b includes a second-wiring-body first portion 45ba and a second-wiring-body second portion 45bb. Each of second-wiring-body first portion 45ba and second-wiring-body second portion 45bb includes a portion extending along the X axis. First-wiring-body first portion 45aa and second-wiring-body first portion 45ba are spaced apart from first-wiring-body second portion 45ab and second-wiring-body second portion 45bb in the Y-axis direction as the second direction.

Second core 21b is spaced apart from first core 21a in the X-axis direction. Third core 21c is spaced apart from first core 21a in the Y-axis direction. Fourth core 21d is spaced apart from third core 21c in the X-axis direction and spaced apart from second core 21b in the Y-axis direction. Four cores (first core 21a to fourth core 21d) are disposed in a matrix (2×2).

Second cooling body 39b is disposed between first core 21a and second core 21b. Second cooling body 39b is spaced apart from each of first core 21a and second core 21b. Third cooling body 39c is disposed between first core 21a and third core 21c and is disposed between second core 21b and fourth core 21d.

Fourth cooling body 39d is disposed opposite to the side on which third cooling body 39c is disposed relative to first core 21a such that first core 21a is retained between fourth cooling body 39d and third cooling body 39c. In addition, fourth cooling body 39d is disposed opposite to the side on which third cooling body 39c is disposed relative to second core 21b such that second core 21b is retained between fourth cooling body 39d and third cooling body 39c.

Fifth cooling body 39e is disposed opposite to the side on which third cooling body 39c is disposed relative to third core 21c such that third core 21c is retained between fifth cooling body 39e and third cooling body 39c. In addition, fifth cooling body 39e is disposed opposite to the side on which third cooling body 39c is disposed relative to fourth core 21d such that fourth core 21d is retained between fifth cooling body 39e and third cooling body 39c. Sixth cooling body 39f is disposed between third cooling body 39c and fourth cooling body 39d. Sixth cooling body 39f is spaced apart from each of third cooling body 39c and fourth cooling body 39d.

Third cooling body 39c is in contact with each of first core 21a, second core 21b, third core 21c, and fourth core 21d. Third cooling body 39c is thermally bonded to each of first core 21a, second core 21b, third core 21c, and fourth core 21d.

Fourth cooling body 39d is in contact with each of first core 21a and second core 21b. Fourth cooling body 39d is thermally bonded to each of first core 21a and second core 21b. Fifth cooling body 39e is in contact with each of third core 21c and fourth core 21d. Fifth cooling body 39e is thermally bonded to each of third core 21c and fourth core 21d. As a result, core 21 (first core 21a to fourth core 21d) is thermally bonded to first cooling body 39a via each of third cooling body 39c, fourth cooling body 39d, and fifth cooling body 39e.

Second cooling body 39b and sixth cooling body 39f each include an E-shaped cooling body 38a as a second-cooling-body first portion and an I-shaped cooling body 38b as a second-cooling-body second portion. E-shaped cooling body 38a is disposed in first cooling body 39a. I-shaped cooling body 38b is disposed to face E-shaped cooling body 38a. E-shaped cooling body 38a has a leg portion 38aa, a leg portion 38ab, and a leg portion 38ac. I-shaped cooling body 38b is disposed to come into contact with each of leg portion 38aa, leg portion 38ab, and leg portion 38ac.

E-shaped cooling body 38a and I-shaped cooling body 38b are disposed to retain wiring member 41 in between from the side on which first cooling body 39a is disposed and from the side opposite to the side on which first cooling body 39a is disposed. E-shaped cooling body 38a is thermally bonded to wiring member 41 via a thermally conductive member 75. I-shaped cooling body 38b is thermally bonded to wiring member 41 via thermally conductive member 76. Consequently, wiring member 41 is thermally bonded to first cooling body 39a via each of second cooling body 39b and sixth cooling body 39f.

Second cooling body 39b and sixth cooling body 39f are structured as a combination of E-shaped cooling body 38a and I-shaped cooling body 38b, but the present disclosure is not limited to E-shaped cooling body 38a and I-shaped cooling body 38b, as long as wiring member 41 can be retained by a combination of cooling bodies. For example, the structure may be a combination of two E-shaped cooling bodies.

The thermal conductivity of each of second cooling body 39b to sixth cooling body 39f is, for example, preferably 1.0 W/(m·K) or more, more preferably 10.0 W/(m·K) or more, and still more preferably 100.0 W/(m·K) or more. In addition, each of second cooling body 39b to sixth cooling body 39f is formed of a metal material, such as copper, iron, aluminum, iron alloy, or aluminum alloy.

In addition, each of second cooling body 39b to sixth cooling body 39f may be formed of a resin having a high thermal conductivity. Each of second cooling body 39b to sixth cooling body 39f may be electrically connected to any other component so as to have the same potential as the ground potential.

In wiring member 41, insertion portion 42a, insertion portion 42b, insertion portion 42c, an insertion portion 42d, and an insertion portion 42e are formed as insertion portion 42. Leg portion 23c (see FIG. 2) of core 21 (first core 21a and second core 21b), leg portion 23b (see FIG. 2) of core 21 (third core 21c and fourth core 21d), third cooling body 39c, leg portion 38ac of E-shaped cooling body 38a (second cooling body 39b), and leg portion 38ab of E-shaped cooling body 38a (sixth cooling body 39f) are inserted through insertion portion 42a.

Leg portion 23a (see FIG. 2) of core 21 (first core 21a and second core 21b) and leg portion 38aa of E-shaped cooling body 38a (second cooling body 39b) are inserted through insertion portion 42b. Leg portion 23a (see FIG. 2) of core 21 (third core 21c and fourth core 21d) and leg portion 38aa of E-shaped cooling body 38a (sixth cooling body 39f) are inserted through insertion portion 42c.

Leg portion 23b (see FIG. 2) of core 21 (first core 21a and second core 21b), leg portion 38ab of E-shaped cooling body 38a (second cooling body 39b), and fourth cooling body 39d are inserted through insertion portion 42d. Leg portion 23c (see FIG. 2) of core 21 (third core 21c and fourth core 21d), leg portion 38ac of E-shaped cooling body 38a (sixth cooling body 39f), and fifth cooling body 39e are inserted through insertion portion 42e.

First-wiring-body first portion 45aa and second-wiring-body first portion 45ba are wound around first core 21a and second core 21b with second cooling body 39b interposed between first core 21a and second core 21b. First-wiring-body second portion 45ab and second-wiring-body second portion 45bb are wound around third core 21c and fourth core 21d with sixth cooling body 39f interposed between third core 21c and fourth core 21d.

In coil device 20 described above, second cooling body 39b and sixth cooling body 39f are each thermally bonded to wiring member 41 via thermally conductive member 75 or thermally conductive member 76. This allows the heat generated in wiring member 41 to be dissipated to first cooling body 39a via second cooling body 39b and sixth cooling body 39f. This can eliminate the need for increasing the size of wiring member 41 for heat dissipation, thus further contributing to the miniaturization of coil device 20 and, in turn, the miniaturization of power converter 1.

In addition, third cooling body 39c is thermally bonded to each of first core 21a, second core 21b, third core 21c, and fourth core 21d. Fourth cooling body 39d is thermally bonded to each of first core 21a and second core 21b. Fifth cooling body 39e is thermally bonded to each of third core 21c and fourth core 21d.

Thus, the heat generated in core 21 (first core 21a to fourth core 21d) can be efficiently conducted to each of third cooling body 39c, fourth cooling body 39d, and fifth cooling body 39e, and further, the heat conducted to each of third cooling body 39c, fourth cooling body 39d, and fifth cooling body 39e can be dissipated to first cooling body 39a. This can eliminate the need for increasing the size of core 21 for heat dissipation, thus further contributing to the miniaturization of coil device 20 and, in turn, the miniaturization of power converter 1.

Coil device 20 has been described using the example in which core 21 is spaced apart from each of second cooling body 39b and sixth cooling body 39f, but core 21 may be disposed to be in contact with each of second cooling body 39b and sixth cooling body 39f. In other words, each of first core 21a and second core 21b may be disposed to be in contact with second cooling body 39b, and each of third core 21c and fourth core 21d may be disposed to be in contact with sixth cooling body 39f.

Bringing core 21 into contact with each of second cooling body 39b and sixth cooling body 39f allows the heat generated in core 21 to be also conducted to each of second cooling body 39b and sixth cooling body 39f, and then dissipated to first cooling body 39a, so that the heat generated in core 21 can be effectively dissipated to first cooling body 39a. This can eliminate the need for increasing the size of core 21 for heat dissipation, thus further contributing to the miniaturization of coil device 20 and, in turn, the miniaturization of power converter 1.

### (Modification)

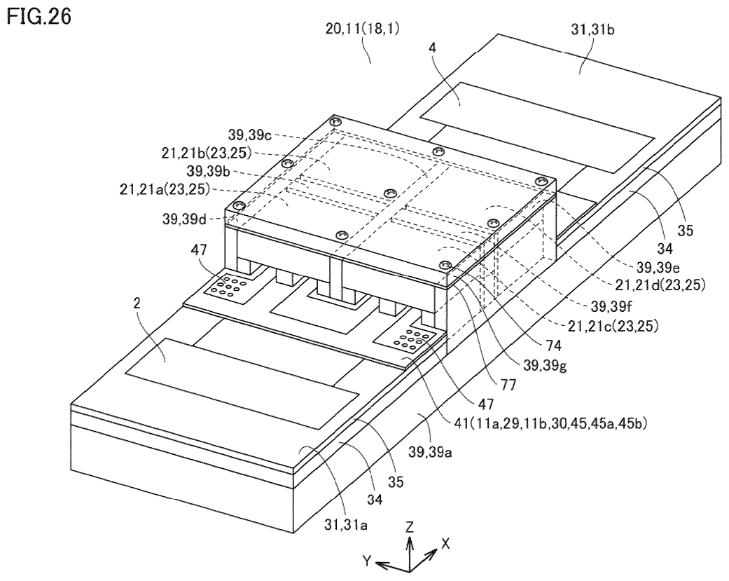

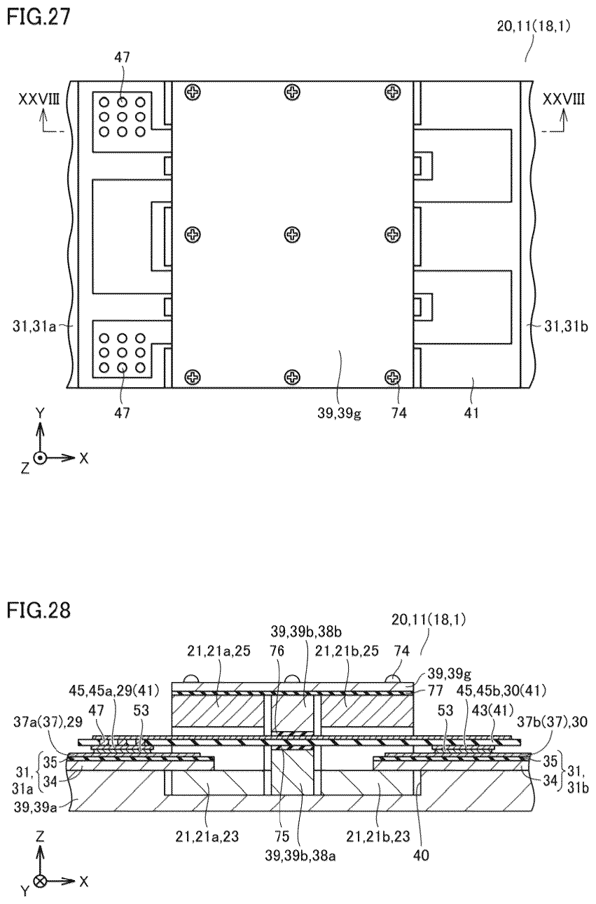

Coil device 20 (power converter 1) according to a modification will be described. As shown in FIGS. 26, 27, and 28, coil device 20 includes a lid cooling body 39g as cooling body 39, in addition to first cooling body 39a to sixth cooling body 39f. Lid cooling body 39g is disposed to cover core 21 (first core 21a to fourth core 21d) and second cooling body 39b to sixth cooling body 39f.

A thermally conductive member 77 is interposed between lid cooling body 39g and core 21, second cooling body 39b to sixth cooling body 39f. Lid cooling body 39g is fixed to second cooling body 39b to sixth cooling body 39f with screw members 74. The other components, which are the same as those of coil device 20 shown in FIGS. 22 to 24 or FIG. 4, are denoted by the same reference signs, and description thereof will not be repeated unless necessary.

For example, the thermal conductivity of lid cooling body 39g is preferably 1.0 W/(m·K) or more, more preferably 10.0 W/(m·K) or more, and still more preferably 100.0 W/(m·K) or more. In addition, lid cooling body 39g is formed of a metal material such as copper, iron, aluminum, iron alloy, or aluminum alloy.

In addition, lid cooling body 39g may be formed of, for example, a resin having a high thermal conductivity. In addition, lid cooling body 39g may be electrically connected to any other component so as to have the same potential as the ground potential.

In coil device 20 described above, thermally conductive member 77 is interposed between lid cooling body 39g and core 21, second cooling body 39b to sixth cooling body 39f. Lid cooling body 39g is thermally bonded to core 21 and second cooling body 39b to sixth cooling body 39f via thermally conductive member 77. In addition, second cooling body 39b to sixth cooling body 39f are thermally bonded to first cooling body 39a.

Thus, the heat generated in core 21 can be conducted to lid cooling body 39g, and further, the heat conducted to lid cooling body 39g can be dissipated to first cooling body 39a via second cooling body 39b to sixth cooling body 39f. This can eliminate the need for increasing the size of core 21 for heat dissipation, thus further contributing to the miniaturization of coil device 20 and, in turn, the miniaturization of power converter 1.

In addition, core 21 and second cooling body 39b to sixth cooling body 39f are fixed to first cooling body 39a together with lid cooling body 39g with screw members 74. This can improve the vibration resistance of coil device 20 and, in turn, the vibration resistance of power converter 1.

Coil device 20 described above has been described using an example of core 21 in which four first cores 21a to fourth 21d are disposed in a matrix (2×2). The number and the arrangement structure of core 21 are not limited thereto.

The coil device in each of the above embodiments has been described using a coil device including a single coil unit by way of example, but a coil device including two or more coil units can be used as the coil device.

Coil devices 20 (power converters 1) described in the respective embodiments can be combined variously as needed.

The embodiments disclosed herein are illustrative and not restrictive. The present disclosure is indicated by the terms of the claims, rather than the scope described above, and is intended to encompass any modifications within the meaning and scope equivalent to the terms of the claims.

The present disclosure includes the following aspects.

### Additional Note 1

A coil device including a coil unit, wherein
the coil unit includes
   one or more cores having a loop-shaped magnetic path,
   a metal base substrate disposed in an inner region of the core surrounded by the core and an outer region of the core, the metal base substrate including a first coil pattern and a second coil pattern formed on a metal base body with an insulating layer in between,
   a first winding portion including the first coil pattern and wound around the core so as to pass through the inner region of the core,
   a second winding portion including the second coil pattern, wound around the core so as to pass through the inner region of the core, and electrically insulated from the first winding portion, and
   one or more cooling bodies including a first cooling body bonded to the metal base body opposite to a side on which the insulating layer is formed,
the metal base substrate includes
   a first metal base substrate in which the first coil pattern is formed, and
   a second metal base substrate in which the second coil pattern is formed, and
the first metal base substrate and the second metal base substrate are disposed to face each other such that an insertion portion is formed between the first metal base substrate and the second metal base substrate, the core being inserted through the insertion portion.

### Additional Note 2

The coil device according to additional note 1, wherein
the metal base substrate has a slit portion so as to be connected to the insertion portion, the slit portion preventing a loop-shaped induced current from flowing through a portion surrounding the core, and
the first metal base substrate and the second metal base substrate are disposed with a distance corresponding to the slit portion in between.

### Additional Note 3

The coil device according to additional note 1 or 2, further including a wiring member including a wiring body wound around the core, wherein
the first coil pattern includes
   a first-coil-pattern first portion, and
   a first-coil-pattern second portion,
the second coil pattern includes
   a second-coil-pattern first portion, and
   a second-coil-pattern second portion,
the wiring body includes
   a first wiring body electrically connecting the first-coil-pattern first portion to the first-coil-pattern second portion, and
   a second wiring body electrically connecting the second-coil-pattern first portion to the second-coil-pattern second portion,
the first winding portion includes the first wiring body, and
the second winding portion includes the second wiring body.

### Additional Note 4

The coil device according to additional note 3, wherein
the wiring member is a printed circuit board, and
the wiring body is disposed in the printed circuit board.

### Additional Note 5

The coil device according to additional note 3 or 4, wherein
the wiring member is disposed opposite to a side on which the first cooling body is disposed relative to the metal base substrate, so as to be located in the inner region of the core surrounded by the core and in the outer region of the core,
the first cooling body has a reception groove portion that receives the core, and
a sealing member is charged between the wiring member and the metal base substrate and between the reception groove portion and the core.

### Additional Note 6

The coil device according to any one of additional notes 1 to 5, wherein a biasing member is interposed between the metal base substrate and the core, the biasing member biasing a portion of the core toward the first cooling body, the portion being located between the metal base substrate and the first cooling body.

### Additional Note 7

The coil device according to any one of additional notes 1 to 6, wherein
the first metal base substrate includes a first extending portion extending from the outer region of the core to the inner region of the core,
the second metal base substrate includes a second extending portion extending from the outer region of the core to the inner region of the core, and
the first metal base substrate and the second metal base substrate are disposed such that the first extending portion and the second extending portion face each other.

### Additional Note 8

The coil device according to additional note 7, wherein each of the first extending portion and the second extending portion has a retaining portion, these retaining portions retaining a portion of the core between the first extending portion and the second extending portion, the portion being located between the metal base substrate and the first cooling body.

### Additional Note 9

The coil device according to additional note 7, wherein each of the first extending portion and the second extending portion includes a warped portion, these warped portions retaining a portion of the core between the metal base substrate and the first cooling body and biasing the portion toward the first cooling body, the portion being located between the metal base substrate and the first cooling body.

### Additional Note 10

The coil device according to additional note 7, wherein the core includes a protruding portion protruding from a portion of the core toward between the first extending portion and the second extending portion, the portion being located between the metal base substrate and the first cooling body.

### Additional Note 11

The coil device according to additional note 7, wherein
the core includes
   a first leg portion around which the first winding portion and the second winding portion are wound, and
   a second leg portion located with a first spacing between the first leg portion and the second leg portion,
the first extending portion and the second extending portion are located to face each other between the first leg portion and the second leg portion,
the first extending portion is formed to have a width, the width decreasing toward a tip of the first extending portion from a first width larger than the first spacing to a second width smaller than the first spacing,
the second extending portion is formed to have a width, the width decreasing toward a tip of the second extending portion from a third width larger than the first spacing to a fourth width smaller than the first spacing, and
the metal base substrate is disposed to retain the core so as to cause the first extending portion to abut on the first leg portion and the second leg portion and cause the second extending portion to abut on the first leg portion and the second leg portion.

### Additional Note 12

The coil device according to additional note 7, wherein a first fixing member is attached, the first fixing member passing through, from each of the first extending portion and the second extending portion, a portion of the core to reach the first cooling body, the portion being located between the metal base substrate and the first cooling body.

### Additional Note 13

The coil device according to additional note 7, wherein
an insulating member is charged between the first extending portion and the second extending portion, and
a second fixing member is attached, the second fixing member passing through the insulating member to reach the first cooling body.

### Additional Note 14

The coil device according to additional note 7, wherein
the first extending portion has a first extension length extending from the outer region of the core to the inner region of the core,
the second extending portion has a second extension length extending from the outer region of the core to the inner region of the core, and
the first extension length is set to any one of a first length larger than the second extension length and a second length smaller than the second extension length.

### Additional Note 15

The coil device according to any one of additional notes 3 to 5, wherein
the core includes a first core and a second core spaced apart from each other in a first direction,
the cooling body includes a second cooling body disposed between the first core and the second core and thermally bonded to the first cooling body, and
each of the first wiring body and the second wiring body is wound around the first core and the second core with the second cooling body interposed between the first core and the second core.

### Additional Note 16

The coil device according to additional note 15, wherein
the second cooling body includes
   a second-cooling-body first portion disposed in the first cooling body, and
   a second-cooling-body second portion disposed to face the second-cooling-body first portion, and
the second-cooling-body first portion and the second-cooling-body second portion are disposed to retain the wiring member in between from a side on which the first cooling body is disposed relative to the wiring member and from a side opposite to the side on which the first cooling body is disposed.

### Additional Note 17

The coil device according to additional note 16, wherein a thermally conductive member is interposed between the second-cooling-body first portion and the wiring member and between the second cooling body and the wiring member.

### Additional Note 18

The coil device according to any one of additional notes 15 to 17, wherein the second cooling body is disposed to be in contact with each of the first core and the second core.

### Additional Note 19

The coil device according to any one of additional notes 3 to 5, wherein
the first wiring body includes a first-wiring-body first portion and a first-wiring-body second portion connected in series,
the second wiring body includes a second-wiring-body first portion and a second-wiring-body second portion connected in series,
each of the first-wiring-body first portion, the first-wiring-body second portion, the second-wiring-body first portion, and the second-wiring-body second portion includes a portion extending in a first direction,
the first-wiring-body first portion and the first-wiring-body second portion are spaced apart from the second-wiring-body first portion and the second-wiring-body second portion in a second direction intersecting the first direction,
the core includes a first core and a third core spaced apart from each other in the second direction,
the cooling body includes a third cooling body, a fourth cooling body, and a fifth cooling body each thermally bonded to the first cooling body,
the third cooling body is disposed between the first core and the third core so as to be in contact with each of the first core and the third core,
the fourth cooling body is disposed opposite to a side on which the third cooling body is disposed relative to the first core, so as to retain the first core between the fourth cooling body and the third cooling body,
the fifth cooling body is disposed opposite to a side on which the third cooling body is disposed relative to the third core, so as to retain the third core between the fifth cooling body and the third cooling body,
each of the first-wiring-body first portion and the second-wiring-body first portion is wound around the first core, and
each of the first-wiring-body second portion and the second-wiring-body second portion is wound around the third core.

### Additional Note 20

The coil device according to any one of additional notes 3 to 5, wherein
the first wiring body includes a first-wiring-body first portion and a first-wiring-body second portion connected in series,
the second wiring body includes a second-wiring-body first portion and a second-wiring-body second portion connected in series,
each of the first-wiring-body first portion, the first-wiring-body second portion, the second-wiring-body first portion, and the second-wiring-body second portion includes a portion extending in a first direction,
the first-wiring-body first portion and the first-wiring-body second portion are spaced apart from the second-wiring-body first portion and the second-wiring-body second portion in a second direction intersecting the first direction,
the core includes
   a first core,
   a second core spaced apart from the first core in the first direction,
   a third core spaced apart from the first core in the second direction, and
   a fourth core spaced apart from the third core in the first direction and spaced apart from the second core in the second direction,
each of the first-wiring-body first portion and the second-wiring-body first portion is wound around the first core and the second core,
each of the first-wiring-body second portion and the second-wiring-body second portion is wound around the third core and the fourth core,
the cooling body includes a lid cooling body thermally bonded to the first cooling body, the lid cooling body being disposed to cover the first core, the second core, the third core, and the fourth core, and
the lid cooling body is thermally bonded to the first core, the second core, the third core, and the fourth core.

### Additional Note 21

The coil device according to additional note 20, wherein
the cooling body includes a second cooling body, a third cooling body, a fourth cooling body, a fifth cooling body, and a sixth cooling body each thermally bonded to the first cooling body,
the second cooling body is disposed between the first core and the second core,
the third cooling body is disposed between the first core and the third core to be in contact with each of the first core and the third core and is disposed between the second core and the fourth core to be in contact with each of the second core and the fourth core,
the fourth cooling body is disposed opposite to a side on which the third cooling body is disposed relative to the first core and the second core, so as to retain the first core and the second core between the fourth cooling body and the third cooling body,
the fifth cooling body is disposed opposite to a side on which the third cooling body is disposed relative to the third core, so as to retain the third core and the fourth core between the fifth cooling body and the third cooling body, and the sixth cooling body is disposed between the third core and the fourth core.

### Additional Note 22

The coil device according to additional note 20 or 21, wherein a thermally conductive member is interposed between the lid cooling body, and the first core, the second core, the third core, and the fourth core.

### Additional Note 23

A power converter including the coil device according to any one of additional notes 1 to 22.

### Additional Note 24

The power converter according to additional note 23, including:
an inverter circuit unit electrically connected to the first coil pattern and disposed on the first metal base substrate, and
a rectifier circuit unit electrically connected to the second coil pattern and disposed on the second metal base substrate.

### INDUSTRIAL APPLICABILITY

The present disclosure is effectively used in a coil device including a core around which a first winding portion and a second winding portion are each wound, and a power converter including the coil device.

### REFERENCE SIGNS LIST

1 power converter; 2 inverter circuit unit; 3 transformation unit; 4 rectifier circuit unit; 5 smoothing circuit unit; 6 input terminal; 7 output terminal; 8 input capacitor; 9, 9a, 9b, 9c, 9d switching element; 10 control circuit unit; 11 transformer; 11a primary winding portion; 11b secondary winding portion; 12, 12a, 12b, 12c, 12d rectifier element; 13 smoothing reactor; 14 smoothing capacitor; 18 coil unit; 20 coil device; 21 core; 21a first core; 21b second core; 21c third core; 21d fourth core; 22a, 22b corner; 23 E-shaped core; 23a, 23b, 23c leg portion; 24 inclined portion; 25 I-shaped core; 27 slit portion; 29 first winding portion; 30 second winding portion; 31 metal base substrate; 31a first metal base substrate; 31b second metal base substrate; 32, 32a, 32b, 32c insertion portion; 33a first extending portion; 33b second extending portion; 34 metal base body; 34a first main surface; 34b second main surface; 35 insulating layer; 35a first main surface; 35b second main surface; 37 coil pattern; 37a first coil pattern; 37af first-coil-pattern first portion; 37as first-coil-pattern second portion; 37b second coil pattern; 37bf second-coil-pattern first portion; 37bs second-coil-pattern second portion; 38a E-shaped cooling body; 38b I-shaped cooling body; 38aa, 38ab, 38ac, leg portion; 39 cooling body; 39a first cooling body; 39b second cooling body; 39c third cooling body; 39d fourth cooling body; 39e fifth cooling body; 39f sixth cooling body; 39g lid cooling body; 39aa main surface; 40 groove portion; 41 wiring member; 42, 42a, 42b, 42c, 42d, 42e insertion portion; 43 insulating portion; 43a first main surface; 43b second main surface; 45 wiring body; 45a first wiring body; 45aa first-wiring-body first portion; 45ab first-wiring-body second portion; 45b second wiring body; 45ba second-wiring-body first portion; 45bb second-wiring-body second portion; 47 through hole conductive portion; 53 bonding member; 55 sealing member; 57 elastic member; 59 protruding and recessed portion; 61a, 61b stepped portion; 63a, 63b upward warped portion; 65a, 65b downward warped portion; 67 protruding portion; 69, 73, 74 screw member; 71 insulating member; 75, 76, 77 thermally conductive member; RP induced current; TA, TB terminal; CR creepage distance; SL, CW, CD length; TA, TB terminal; WA, WB width; DL spacing; CP central portion; EFL, ESL length; PT1 current path; PT2 current path.

1.-20. (canceled)

21. A coil device comprising a coil unit, wherein
the coil unit includes
one or more cores having a loop-shaped magnetic path,
a metal base substrate disposed in an inner region of the core surrounded by the core and an outer region of the core, the metal base substrate including a first coil pattern formed on a metal base body with an insulating layer in between, and
a first winding portion including the first coil pattern and wound around the core so as to pass through the inner region of the core,
the metal base substrate includes
a first metal base substrate in which the first coil pattern is formed, and
a second metal base substrate in which the second coil pattern is formed, and
the first metal base substrate and the second metal base substrate are disposed to face each other such that an insertion portion is formed between the first metal base substrate and the second metal base substrate, the core being inserted through the insertion portion.

22. The coil device according to claim 21, wherein
the metal base substrate includes a second coil pattern formed on the metal base body with the insulating layer in between, and
the coil unit includes
a second winding portion including the second coil pattern, wound around the core so as to pass through the inner region of the core, and electrically insulated from the first winding portion, and
one or more cooling bodies including a first cooling body bonded to the metal base body opposite to a side on which the insulating layer is formed.

23. The coil device according to claim 21, wherein
the metal base substrate has a slit portion so as to be connected to the insertion portion, the slit portion preventing a loop-shaped induced current from flowing through a portion surrounding the core, and
the first metal base substrate and the second metal base substrate are disposed with a distance corresponding to the slit portion in between.

24. The coil device according to claim 22, further comprising a wiring member including a wiring body wound around the core, wherein
the first coil pattern includes
a first-coil-pattern first portion, and
a first-coil-pattern second portion,
the second coil pattern includes
a second-coil-pattern first portion, and
a second-coil-pattern second portion,
the wiring body includes
a first wiring body electrically connecting the first-coil-pattern first portion to the first-coil-pattern second portion, and
a second wiring body electrically connecting the second-coil-pattern first portion to the second-coil-pattern second portion,
the first winding portion includes the first wiring body, and
the second winding portion includes the second wiring body.

25. The coil device according to claim 24, wherein
the wiring member is a printed circuit board, and
the wiring body is disposed in the printed circuit board.

26. The coil device according to claim 24, wherein
the wiring member is disposed opposite to a side on which the first cooling body is disposed relative to the metal base substrate, so as to be located in the inner region of the core surrounded by the core and in the outer region of the core,
the first cooling body has a reception groove portion that receives the core, and
a sealing member is charged between the wiring member and the metal base substrate and between the reception groove portion and the core.

27. The coil device according to claim 22, wherein a biasing member is interposed between the metal base substrate and the core.

28. The coil device according to claim 22, wherein
the first metal base substrate includes a first extending portion extending from the outer region of the core to the inner region of the core,
the second metal base substrate includes a second extending portion extending from the outer region of the core to the inner region of the core, and
the first metal base substrate and the second metal base substrate are disposed such that the first extending portion and the second extending portion face each other.

29. The coil device according to claim 28, wherein each of the first extending portion and the second extending portion has a retaining portion, these retaining portions retaining a portion of the core between the first extending portion and the second extending portion, the portion being located between the metal base substrate and the first cooling body.

30. The coil device according to claim 28, wherein each of the first extending portion and the second extending portion includes a warped portion, these warped portions retaining a portion of the core between the metal base substrate and the first cooling body and biasing the portion toward the first cooling body, the portion being located between the metal base substrate and the first cooling body.

31. The coil device according to claim 28, wherein the core includes a protruding portion protruding from a portion of the core toward between the first extending portion and the second extending portion, the portion being located between the metal base substrate and the first cooling body.

32. The coil device according to claim 28, wherein
the core includes
a first leg portion around which the first winding portion and the second winding portion are wound, and
a second leg portion located with a first spacing between the first leg portion and the second leg portion,
the first extending portion and the second extending portion are located to face each other between the first leg portion and the second leg portion,
the first extending portion is formed to have a width, the width decreasing toward a tip of the first extending portion from a first width larger than the first spacing to a second width smaller than the first spacing,
the second extending portion is formed to have a width, the width decreasing toward a tip of the second extending portion from a third width larger than the first spacing to a fourth width smaller than the first spacing, and
the metal base substrate is disposed to retain the core so as to cause the first extending portion to abut on the first leg portion and the second leg portion and cause the second extending portion to abut on the first leg portion and the second leg portion.

33. The coil device according to claim 28, wherein a first fixing member is attached, the first fixing member passing through, from each of the first extending portion and the second extending portion, a portion of the core to reach the first cooling body, the portion being located between the metal base substrate and the first cooling body.

34. The coil device according to claim 28, wherein
an insulating member is provided between the first extending portion and the second extending portion, and
a second fixing member is attached, the second fixing member passing through the insulating member to reach the first cooling body.

35. The coil device according to claim 28, wherein
the first extending portion has a first extension length extending from the outer region of the core to the inner region of the core,
the second extending portion has a second extension length extending from the outer region of the core to the inner region of the core, and
the first extension length is set to any one of a first length larger than the second extension length and a second length smaller than the second extension length.

36. The coil device according to claim 24, wherein
the core includes a first core and a second core spaced apart from each other in a first direction,
the cooling body includes a second cooling body disposed between the first core and the second core and thermally bonded to the first cooling body, and
each of the first wiring body and the second wiring body is wound around the first core and the second core with the second cooling body interposed between the first core and the second core.

37. The coil device according to claim 36, wherein
the second cooling body includes
a second-cooling-body first portion disposed in the first cooling body, and
a second-cooling-body second portion disposed to face the second-cooling-body first portion, and
the second-cooling-body first portion and the second-cooling-body second portion are disposed to retain the wiring member in between from a side on which the first cooling body is disposed relative to the wiring member and from a side opposite to the side on which the first cooling body is disposed.

38. The coil device according to claim 24, wherein
the first wiring body includes a first-wiring-body first portion and a first-wiring-body second portion connected in series,
the second wiring body includes a second-wiring-body first portion and a second-wiring-body second portion connected in series,
each of the first-wiring-body first portion, the first-wiring-body second portion, the second-wiring-body first portion, and the second-wiring-body second portion includes a portion extending in a first direction,
the first-wiring-body first portion and the first-wiring-body second portion are spaced apart from the second-wiring-body first portion and the second-wiring-body second portion in a second direction intersecting the first direction,
the core includes a first core and a third core spaced apart from each other in the second direction,
the cooling body includes a third cooling body, a fourth cooling body, and a fifth cooling body each thermally bonded to the first cooling body,
the third cooling body is disposed between the first core and the third core so as to be in contact with each of the first core and the third core,
the fourth cooling body is disposed opposite to a side on which the third cooling body is disposed relative to the first core, so as to retain the first core between the fourth cooling body and the third cooling body,
the fifth cooling body is disposed opposite to a side on which the third cooling body is disposed relative to the third core, so as to retain the third core between the fifth cooling body and the third cooling body,
each of the first-wiring-body first portion and the second-wiring-body first portion is wound around the first core, and
each of the first-wiring-body second portion and the second-wiring-body second portion is wound around the third core.

39. The coil device according to claim 24, wherein
the first wiring body includes a first-wiring-body first portion and a first-wiring-body second portion connected in series,
the second wiring body includes a second-wiring-body first portion and a second-wiring-body second portion connected in series,
each of the first-wiring-body first portion, the first-wiring-body second portion, the second-wiring-body first portion, and the second-wiring-body second portion includes a portion extending in a first direction,
the first-wiring-body first portion and the first-wiring-body second portion are spaced apart from the second-wiring-body first portion and the second-wiring-body second portion in a second direction intersecting the first direction,
the core includes
a first core,
a second core spaced apart from the first core in the first direction,
a third core spaced apart from the first core in the second direction, and
a fourth core spaced apart from the third core in the first direction and spaced apart from the second core in the second direction,
each of the first-wiring-body first portion and the second-wiring-body first portion is wound around the first core and the second core,
each of the first-wiring-body second portion and the second-wiring-body second portion is wound around the third core and the fourth core,
the cooling body includes a lid cooling body thermally bonded to the first cooling body, the lid cooling body being disposed to cover the first core, the second core, the third core, and the fourth core, and
the lid cooling body is thermally bonded to the first core, the second core, the third core, and the fourth core.

40. A power converter comprising the coil device according to claim 21.
